(19) United States
(12) Patent Application Publication
(10) Pub. No.: US 2003/0029942 A1
(43) Pub. Date: Feb. 13, 2003

(54) Unipolarity powder coating systems including improved tribocharging and corona guns

(76) Inventors: Michael R. Sanner, Amherst, OH (US); William R. Rehman, Vermillion, OH (US); Harry J. Lader, Lakewood, OH (US)

Correspondence Address: CALFEE, HALTER & GRISWOLD, LLP, 800 SUPERIOR AVENUE, SUITE 1400, CLEVELAND, OH, 44114, US

(21) Appl. No.: 10/139,939

(22) Filed: May 7, 2002

Related U.S. Application Data
(63) Continuation-in-part of application No. 09/901,162, filed on Jul. 9, 2001.
Application No. 09/901,162 is a continuation-in-part of application No. 09/724,363, filed on Nov. 28, 2000.
(60) Provisional application No. 60/217,261, filed on Jul. 11, 2000.

(51) Int. Cl. B05B 5/00

(52) U.S. Cl. 239/690

(57) ABSTRACT

A plurality of unconventional negative tribo-charging materials are described for use as the powder contact surfaces in tribocharging and corona powder spray guns, gun components, and powder delivery system components. The invention also provides a short barrel tribo-charging powder spray gun having an interchangeable powder contact insert and nozzle, with turbulence inducing air jets. The invention further provides novel tribocharging and corona gun designs. Improved powder coating systems are made possible wherein, for example, negative tribo guns can be utilized with negative corona guns to coat different parts of the same workpiece in a powder coating system. Also provided is an inside-out configuration in which pressurized air directs powder coating material outward towards a charging surface. Additional configurations provide air jet induced tribocharging and conventional tribocharging portions combined in a single gun.

### RELATED APPLICATIONS

This application is a continuation-in-part of pending U.S. patent application Ser. No. 09/901,162 filed on Jul. 9, 2001 for UNIPOLARITY POWDER COATING SYSTEMS INCLUDING IMPROVED TRIBOCHARGING AND CORONA GUNS, which is a continuation-in-part of pending U.S. patent application Ser. No. 09/724,363 filed on Nov. 28, 2000 for UNIPOLARITY POWDER COATING SYSTEMS INCLUDING IMPROVED TRIBOCHARGING AND CORONA GUNS, the entire disclosures of which are fully incorporated herein by reference. All of the above patent applications and the present application also claim the benefit of U.S. Provisional patent application serial No. 60/217,261 filed on Jul. 11, 2000 for A UNIPOLARITY POWDER COATING SYSTEM INCLUDING AN IMPROVED TRIBOCHARGING GUN, UNIPOLARITY GUN AND METHOD FOR MAKING SAME, the entire disclosure of which is fully incorporated herein by reference.

### FIELD OF THE INVENTION

This invention relates to powder coating systems which use corona and tribocharging powder spray guns to apply an electrostatic charge to powder for deposition on a substrate.

### BACKGROUND OF THE INVENTION

There are two basic types of powder spray guns which are commonly used in the electrostatic powder spray coating of articles. The most common type of spray gun is the corona type, which has a high voltage charging electrode which produces a corona to charge the powder. Typically, corona guns are designed to charge the powder negatively. One major disadvantage of corona guns is that they do not coat the interior comers of parts well due to the strong electrostatic field or Faraday caging effect produced by the corona electrode. A second disadvantage to corona guns is that back ionization may occur due to the formation of free ions which results in pinholing or an orange peel surface of the part to be coated. Another disadvantage to these type of guns is that the system components such as the nozzle, and diffuser as well as the powder deliver system components such as the pump, hopper and other parts in contact with the powder delivery system are typically made of materials such as polyethylene or polytetrafluoroethylene (PTFE). While these materials have the advantage of low impact fusion, they have the disadvantage of positively charging the powder, which can impair the negative corona charging process because the final or maximum charge on the powder is diminished. Further, more voltage is often required in order to counteract the positive polarity charging of the system. In addition, this positive polarity tribocharging may cause breakdown of the powder conveying components such as the hose, which connects the pump to the spray gun.

A second type of gun which is also commonly used is a tribocharging gun in which the powder is charged by frictional contact with the interior surfaces of the gun. One advantage to triboelectric guns is that the powder can easily penetrate corners of parts to be coated because the gun does not produce a strong electric field like a corona gun does.

### SUMMARY OF THE INVENTION

The invention provides novel electrostatic powder coating guns and system components in which powder is pre-charged to the same polarity as a charge applied by the powder spray gun in order to increase and enhance the applied charge and the transfer efficiency. Also novel powder coating methods are described.

In accordance with one aspect of the invention, an apparatus for spraying powder coating material is described. The apparatus has a powder flow path, wherein the powder flow path has a charging surface for triboelectrically charging powder coating material which comes in contact with the charging surface, and the charging surface comprises a negative tribocharging material selected from polyamide resin blends, fiber reinforced polyamides, aminoplastic resins and acetal polymers.

In accordance with another aspect of the invention, an apparatus for spraying powder coating material has a powder flow path, wherein the powder flow path has a charging surface for triboelectrically charging powder coating material which comes in contact with the charging surface, and wherein one or more air passages are formed through the charging surface, the air passages being in a fluid communication with a source of compressed air.

In accordance with another aspect of the invention, an apparatus for spraying powder coating material is described. The apparatus has a powder flow path through which the powder coating material flows, wherein the powder flow path has a first charging surface for triboelectrically charging powder coating material which comes in contact with the first charging surface, the first charging surface comprising a tribocharging material having a first charging polarity, the apparatus further comprising a component through which powder coating material also flows, the component having a second charging surface which also comprises a tribocharging material having the first charging polarity.

In accordance with another aspect of the invention, a system for applying powder coating materials to articles is described. The system includes a powder feed apparatus for supplying powder coating material and an apparatus for spraying powder coating material received from the feed apparatus. The spraying apparatus has an electrode for charging the powder coating material a first charging polarity. The feed apparatus includes a component having a charging surface for triboelectrically charging powder coating material which comes in contact with the charging surface, the charging surface comprising a tribocharging material having the first charging polarity.

In accordance with another aspect of the invention, a system for applying powder coating materials to articles is described. The system includes at least one corona charging spraying apparatus and at least one tribocharging spraying apparatus. The corona charging spraying apparatus has an electrode for charging the powder coating material a first charging polarity. The tribocharging spraying apparatus has a powder flow path, wherein the powder flow path has a charging surface for triboelectrically charging powder coating material which comes in contact with the charging surface, the powder coating material being charged to the first polarity by the charging surface of the tribocharging spraying apparatus.

In accordance with another aspect of the invention, a tribocharging powder spraying apparatus is described. The apparatus includes a body having an internal bore, a wear tube located within the internal bore, and an open passageway provided between the internal bore and the wear tube, with at least one air jet passageway being provided through the wear tube. The air jet passageway provides fluid communication between the open passageway and the interior of the wear tube. The wear tube has a charging surface for triboelectrically charging powder coating material which comes in contact with the charging surface. The open passageway is in fluid communication with a source of compressed air, whereby compressed air flows from the open passageway through the air jet passageway into the interior of the wear tube to affect the flow of powder coating material through the wear tube.

In accordance with another aspect of the invention, a system for applying powder coating materials to articles is described. The system includes a powder feed apparatus for supplying powder coating material and an apparatus for spraying powder coating material received from the feed apparatus. The feed apparatus includes a component having a charging surface for triboelectrically charging powder coating material that comes in contact with the charging surface. The component charging surface is comprised of a negative tribocharging material selected from polyamide resin blends, fiber reinforced polyamides, aminoplastic resins and acetal polymers.

In accordance with another aspect of the invention, a triboelectric powder coating gun has a component which includes a triboelectric charging surface, wherein the component is capable of assembly into the gun in at least two different positional orientations. Still a further aspect of the invention provides a triboelectric powder coating gun having a triboelectric charging surface and an air jet which impinges on the charging surface, further including a ground element which is positioned upstream of the charging surface.

In accordance with another aspect of the invention, spray patterns from electrostic spray guns are shaped so as to slow down and to more uniformly distribute powder throughout the powder cloud or spray that is ejected from the spray gun nozzle. In one embodiment, a nozzle is provided with two or more primary openings or slots formed therein that are angled so as to direct respective portions of the powder at each other. The impinging powder spray portions slow down the powder spray and cause a ballooning or spreading effect to widen the primary spray pattern. The nozzle slots are arranged so as to reduce or minimize the likelihood that powder particles could pass through the nozzle and out a slot without contacting a surface of the nozzle. The nozzle slots also produce a backpressure effect that increases random powder particle collisions with each other and nozzle surfaces to enhance tribocharging of the powder.

In accordance with another aspect of the invention, spray patterns are shaped by adjusting flow characteristics about the outer periphery or envelope of the primary spray pattern. In one embodiment, a spray nozzle includes one or more secondary openings that function as vents to reduce pressure build up within the nozzle and to provide an air flow and powder flow about the outer periphery of the powder cloud or spray pattern produced by the primary nozzle slots. This additional flow about the periphery of the primary spray pattern adds more powder particles to the peripheral region of the spray pattern thereby increasing the uniformity of powder distribution in the resultant spray pattern. The vents may be used in combination with the angled nozzle slots or with a conventional nozzle orifice design.

Further powder spray pattern shaping and uniformity, as well as velocity reduction and forward direction, may be augmented by the use of one or more deflectors. The deflector may be made of tribocharging material.

In accordance with another aspect of the invention, a circular spray pattern is effected with a spray nozzle that is preferably but not necessarily a unitary structure. In one embodiment, a spray nozzle includes a conical slot provided by a cone shaped deflector that is integrally supported at one end of the nozzle by a number of ribs. The size of the spray pattern may be determined in part by the size, shape and angle of the conical slot.

In accordance with another aspect of the invention, a spray nozzle is provided that includes material or a surface that produces a tribocharging effect to powder particles ejected through the nozzle. Various openings and slots may be used to enhance the tribocharging effect. In accordance with another aspect of the invention, a spray gun operator is grounded in common with the ground feedback of a tribocharge spray gun. In one embodiment this is effected by a grounded gun handle coupled to the feedback or discharge ground path for the spray gun. A further aspect of the invention contemplates a modular tribocharging gun design that accommodates gun length modifications as needed including “on the fly” gun length changes.

The various aspects of the present invention may be used individually or in a number of different combinations and subcombinations for a spray gun.

These and other aspects of the invention are herein described in detail with reference to the accompanying Figures.

### DESCRIPTION OF THE FIGURES

FIG. 1 is a cross-sectional view of a tribocharging gun which incorporates the novel unconventional materials of the invention;

FIG. 2 is a cross-sectional view of a novel short barrel tribocharging gun of the present invention;

FIGS. 3A through 3D illustrate a portion of the insert of the gun of FIG. 2 in which the airjets are arranged in various opposed configurations;

FIG. 4A illustrates a cross-sectional view of the insert of the short barrel tribocharging gun of FIG. 2, aft looking forward, in which the airjets are not vertically offset from each other;

FIGS. 4B through 4E illustrate cross-sectional views of the insert of the short barrel tribocharging gun of FIG. 2, aft looking forward, in which the airjets are vertically offset from each other a perpendicular distance H;

FIGS. 5A and 5B each illustrate a cross-sectional view of the insert of the short barrel tribocharging gun of FIG. 2, aft looking forward, in which a first set of airjets as shown in FIG. 5A are not rotationally offset from a second set of downstream airjets as shown in FIG. 5B;

FIGS. 5E through 5F each illustrate a cross-sectional view of the insert of the short barrel tribocharging gun of FIG. 2, aft looking forward, in which a first set of airjets as shown in FIGS. 5C and 5E are rotationally offset from a second set of downstream airjets as shown in FIGS. 5D, and 5F, respectively;

FIGS. 5G and 5H each illustrate a cross-sectional view of the insert of the short barrel tribocharging gun of FIG. 2, aft looking forward, in which a first set of airjets as shown in FIG. 5G are not rotationally offset from a single downstream airjet as shown in FIG. 5H;

FIG. 6 illustrates a cross-sectional view of a corona gun which incorporates the novel unconventional materials of the invention;

FIG. 7 illustrates a cross-sectional view of a flat spray nozzle which incorporates the novel unconventional materials and one or more airjets of the invention;

FIG. 8 is a cross-sectional view of a powder pump of a powder coating system which incorporates the novel unconventional materials of the invention;

FIG. 9 illustrates a perspective schematic view of powder coating system which includes a corona and tribocharging gun which charge the powder to the same polarity;

FIG. 10 is a cross-sectional view of an alternate embodiment of a tribocharging gun of the present invention which incorporates airjets;

FIG. 10A is a cutaway view of the gun shown in FIG. 10 in the direction 10A-10A;

FIG. 11 is a cross-sectional view of yet another alternate embodiment of a tribocharging gun of the present invention which incorporates airjets arranged in a helical pattern;

FIG. 11A is a cutaway view of the gun shown in FIG. 11 in the direction 11A-11A;

FIG. 12 is a cross-sectional illustration of another embodiment of a tribocharging gun using air jets;

FIG. 13 is a cross-sectional illustration of a modified version of the gun in FIG. 12 having a portion with air jets and a tribocharging post-charge portion;

FIG. 14 is another cross-sectional illustration of a modified version of the gun in FIG. 12 in which there is a pre-charge portion with air jets followed by a tribocharging portion;

FIGS. 15 and 16 are cross-sectional views of two embodiments of an inside-out gun in accordance with the invention;

FIG. 17 illustrates an embodiment of an air jet induced charging gun in a conventional manual spray gun configuration;

FIGS. 18A-D illustrate additional embodiments of the gun style of FIG. 17 using different extension lengths;

FIG. 19 illustrates an inside-out gun in a manual gun configuration;

FIG. 20 illustrates a spray gun that incorporates an inside-out configuration with an outside-in configuration;

FIGS. 21-24 illustrate another embodiment of the invention;

FIGS. 25-27 are longitudinal cross-section, elevation and front end views respectively of a spray nozzle with angled slots;

FIG. 28 is a perspective view of the spray nozzle of FIGS. 25-27;

FIGS. 29-31 are longitudinal cross-section, elevation and front end views respectively of a conical spray nozzle;

FIG. 32 is a perspective view of the spray nozzle of FIGS. 29-31;

FIG. 33 is a perspective view of a first embodiment of a deflector;

FIG. 34 is the deflector of FIG. 33 in longitudinal cross-section;

FIG. 35 is a longitudinal cross-section of a spray gun using the nozzle of FIG. 32 and deflector of FIG. 34;

FIG. 36 is a perspective view of an alternative deflector design;

FIG. 37 is the deflector of FIG. 36 in longitudinal cross-section;

FIG. 38 is a longitudinal cross-section of a spray gun using a nozzle of FIG. 32 and a deflector of FIG. 36;

FIG. 39 is a gun extension assembly in longitudinal cross-section;

FIG. 40 is a longitudinal cross-section of a splice used in the assembly of FIG. 39;

FIG. 41 is a spray gun in longitudinal cross-section using a gun extension assembly of FIG. 39; and

FIG. 42 is a partially exploded illustration in longitudinal cross-section of the gun of FIG. 41 to show assembly of the gun extension for modifying gun length.

### DETAILED DESCRIPTION OF PREFERRED AND ALTERNATE EMBODIMENTS

The following Detailed Description of Preferred and Alternate Embodiments is divided into the following sections. Section I provides a detailed description of a novel tribocharging gun which charges a powder to a negative polarity by frictional contact with novel use of unconventional materials as described in more detail below. Section II provides a detailed description of a novel short barrel tribocharging gun which can charge powder to a positive or negative polarity depending upon the materials selected for frictional contact with the tribocharging surfaces of the gun. Sections III and IV concern a corona gun and powder supply system, respectively, with the corona gun and system including components which charge the powder to the same polarity as the corona gun by frictionally contacting the powder with tribocharging surfaces comprised of the desired positive or negative tribocharging material. Section V provides a detailed description of a powder coating system which includes corona and tribocharging guns which charge the powder to the same polarity so that the tribocharging gun can be used in conjunction with the corona gun to coat the same workpiece. Finally, Section VI provides a detailed description of an alternate tribocharging gun embodiment which utilizes air jets.

I. Negative Tribocharging Gun Constructed From Unconventional Materials

A. Unconventional Negative Charging Tribomaterials

A part of this invention is the discovery of what will be referred to herein as “unconventional negative charging tribomaterials”. These materials are useful as powder contact surfaces for negatively charging powder coating material by frictional contact with the powder contact surfaces of a powder spray gun. The term “negative charging tribomaterials” means materials which impart a negative charge to powders, such as powdered paints, upon frictional impact with the surface of the negative charging tribomaterials.

As described in more detail in this application, the unconventional negative charging tribomaterials could be used as the interior surfaces of tribocharging or corona powder spray guns, as well as spray gun components and powder delivery system components such as the diffuser, powder tube, feed hopper, and pump as described in more detail in Section IV. Although the unconventional negative charging tribomaterials are known generally, they have not been previously known to be useful in spray guns in order to tribocharge powder coating materials.

The non-conventional negative charging tribomaterials are selected from polyamide blends, fiber reinforced polyamide resins, the aminoplastic resins, acetal polymers or mixture thereof, and are described in more detail, below. These materials not only charge well negatively but they also do not experience impact fusion problems as significant as negative tribo charging materials which have been used in the past such as nylon.

1. The Polyamide Blend

The polyamide blend comprises a blend of a polyamide polymer and a second polymer selected from the group consisting of: polyethylene, polypropylene, halogenated hydrocarbon resin, and mixtures thereof. The polyamide polymer is preferably present in the polyamide blend from 50% to 96%, more preferably from 70% to 90%, by weight. The second polymer is preferably present in the polyamide blend from about 4% to about 50%, more preferably from about 10% to about 30%, most preferably from about 15% to about 25% by weight.

The halogenated hydrocarbon resin is preferably a fluorinated hydrocarbon resin, such as for example, polytetrafluoroethylene, (also known as PTFE); a copolymer of tetrafluoroethylene and hexafluoropropylene (also known as FEP); and a copolymer of tetrafluoroethylene and perfluorinated vinyl ether (also known as PFA). Suitable fluorinated resins are commercially available under the tradename TEFLON® from DuPont.

The polyamide polymer in the polyamide blend is preferably a nylon. Preferred grades of nylon are nylon 6/6, nylon 6/12, nylon 4/6 and nylon 11. A suitable polyamide blend is a 20% polytetrafluoethylene and 80% nylon 6/6 commercially available under the trade name Lubricon RL 4040 from LNP Engineering Plastics, Division of ICI Advanced Materials, Exton, Pennsylvania. A suitable blend is about a 5% polytetrafluoethylene and about a 95% nylon 6/6 commercially available under the trade name Lubricon RL 4010 from LNP Engineering Plastics, Division of ICI Advanced Materials, Exton, Pennsylvania.

### EXAMPLE 1

Individual discs of a 20% polytetrafluoethylene and 80% nylon 6/6, polyamide/halogenated hydrocarbon resin blend were prepared. For comparison, coupons of conventional material, that is, nylon and Teflon were also prepared.

The relative transfer efficiency was determined by spraying powder paint from a flat spray nozzle with a 0.450 inch by 0.065 inch slot at an air flow rate of 4 cubic feet per minute onto a disc at a 45° angle. The powder impacted the surface of the disc of the tribocharging material and was deflected from the disc onto a grounded metal target. The powder exiting the nozzle had a measured initial charge of zero. Thus, all of the powder charging was due to impacting the tribomaterial. The amount of powder adhered to the target as compared to the total powder sprayed is defined as the relative transfer efficiency. Typically, 50 grams of polyester epoxy powder from Ferro Corporation was the powder used for the tests. Since this relative transfer efficiency test is done by a single impact from a coupon, the values tend to be lower than for numerous contacts using a tribocharging gun.

The powder used in the evaluation was a polyester epoxy powder, designated 153W-121, from Ferro Corporation. The results are shown below in Table I.

### EXAMPLE 2

Individual discs of a 5% PTFE and 95% nylon 6/6, polyamide blend were prepared and the transfer efficiency was evaluated as in Example 1. The results are shown below in Table I.

The advantage of using the polyamide blends in powder spray guns is that they increase the powder charging due to increased discharging of the tribocharged gun surfaces. The increased surface discharging is due to the incompatible polymers which provide for a leakage path that is not present in the homogeneous polymer. Another advantage of using these polyamide blends is that reduced moisture absorption of nylons occur when they are filled with PTFE or polyethylene.

2. The Fiber Reinforced Polyamide Resin

The fiber reinforced polyamide resin comprise a polyamide polymer filled with polyaramide fibers. Preferably there is from about 50% to about 99%, more preferably from about 85% to about 95% of the polyamide polymer. Preferably there is from about 1% to about 50%, and more preferably from about 5% to about 15% of the polyaramide fiber in the polyamide polymer.

The polyamide polymer in the fiber reinforced polyamide resin is preferably commercially available polyamide polymers. Suitable polyamides are for example, nylons.

The polyaramide fibers are long chain synthetic aromatic polyamides in which at least 85% of the amide linkages are attached directly to two aromatic rings. A suitable polyaramide fiber is a poly(p-phenylene terephthalamide) commercially available under the trade name KEVLAR®, from DuPont. The polyaramide fiber, poly(m-phenylene terephthalamide), commercially available under the trade name Nomex, from DuPont, is less preferred. Examples of other polyaramide fibers are the polymer comprising polymerized units of p-aminobenzhydrazide and terephthaloyl chloride; a suitable such polymer is commercially available under the trade name PABH-T X-500 from Monsanto.

A suitable fiber reinforced polyamide resin is 10% KEVLAR® in 90% nylon 6,6 available under the trade name Lubricon RA from LNP Engineering Plastics, Division of ICI Advanced Materials, Exton, Pa.

### EXAMPLE 3

Individual discs of the fiber reinforced polyamide resin were prepared. For comparison, coupons of conventional, non fiber containing nylon and Teflon were also prepared. The relative transfer efficiency was determined as in Example 1. The results are shown below in Table I.

TABLE I

| | | DISK | | RELATIVE |
|---|---|---|---|---|
| | | THICK- | | TRANSFER |
| | | NESS | POLAR- | EFFI- |
| EXAMPLE | MATERIAL | (IN) | ITY | CIENCY % |
| Comparative | Nylon 6, 6 | 0.155 | − | 16.5 |
| 1 | 5% PTFE in Nylon | 0.250 | − | 21.3 |
| | 6, 6 | | | |
| 2 | 20% PTFE in Nylon | 0.250 | − | 24.7 |
| | 6, 6 | | | |
| 3 | 10% KEVLAR ® in | 0.123 | − | 39.2 |
| | Nylon 6, 6 | | | |
| Comparative | 100% KEVLAR ® | — | + | 54.3 |
| | tow fibers | | | |
| 4 | Nylon R MoS₂ filled | 0.118 | − | 22.4 |

Surprisingly, despite the fact that the KEVLAR® tow fiber charges powder positively in the comparative example, the addition of such fiber to the nylon which charges negatively, increased the relative transfer efficiency.

3. The Aminoplastic Resins

The aminoplastic resins are comprised of polymerized units of an amine monomer and an aldehyde monomer. Preferred aminio plastic resins are aniline formaldehyde resins, urea formaldehyde resins and melamine formaldehyde resins. Optionally, the aminoplastic resins further comprise cellulose such as alpha-cellulose and pigments.

Suitable molding grade melamine formaldehyde resins filled with alpha cellulose, are commercially available under the trade name Perstorp 752026 white melamine or Perstorp 775270 red melamine available from Perstorp Compounds, Inc. in Florence, Mass. Another suitable melamine resin is a melamine phenol-formaldehyde copolymer, commercially available under the trade name Plenco 00732, from Plenco Plastics Engineering Company in Sheboygan, Wis.

Another suitable melamine resin is a melamine formaldehyde polymer, Perstop 752-046, available from Perstorp Compounds, Inc. in Florence, Mass.

### EXAMPLE 4

Individual discs of the white melamine formaldehyde resin, Perstorp 752026, filled with alpha cellulose were obtained. For comparison, discs of conventional nylon 6/6 were also prepared. Relative transfer efficiency was determined as in Example 1. The results are shown below in Table II.

### EXAMPLE 5

Individual discs of the red peppercorn melamine formaldehyde resin, Perstorp 775270, filled with alpha cellulose were obtained. For comparison, discs of conventional nylon were also prepared. The relative transfer efficiency was determined as in Example 1. The results are shown below in Table II.

### EXAMPLE 6

Individual discs of the melamine phenol-formaldehyde resin, Plenco 00732 were obtained. For comparison, discs of conventional nylon were also prepared. The relative transfer efficiency was determined as in Example 1. The results are shown below in Table II.

### EXAMPLE 7

Individual discs of the white melamine formaldehyde resin Perstorp 752-046, were obtained. For comparison, discs of conventional nylon were also prepared. The relative transfer efficiency was determined as in Example 1. The results are shown below in Table II.

TABLE II
RELATIVE TRANSFER EFFICIENCY OF FERRO 153W-121
ON CONTACT WITH AMINO RESIN COUPONS

| | | | RELATIVE |
|---|---|---|---|
| EXAMPLE | MATERIAL | POLARITY | TE (%) |
| Comparative | Nylon 6/6 | Negative | 16.5 |
| 4 | Perstorp 752026 white | Negative | 37.7 |
| | Melamine | | |
| 5 | Perstorp 775270 red | Negative | 37.0 |
| | Peppercorn melamine | | |
| 6 | Plenco 00732 melamine/ | Negative | 28.7 |
| | phenol formaldehyde | | |
| 7 | Perstorp 752-046 | Negative | 44.9 |
| | Melamine-formaldehyde | | |

Powder flow rate=1.5 g/s

### EXAMPLES 8-10

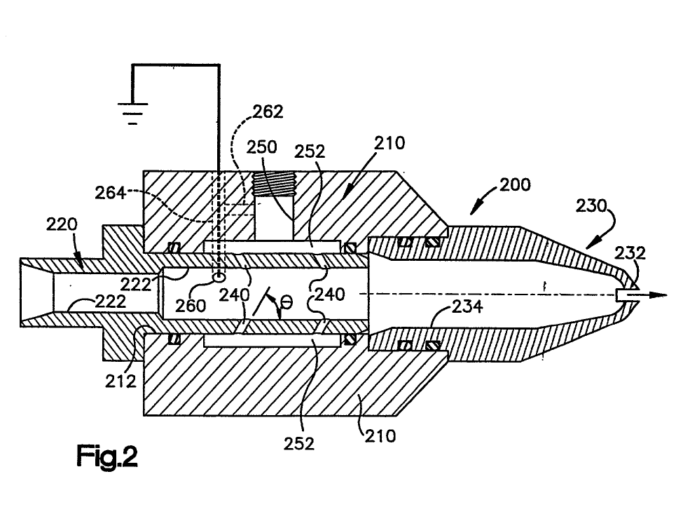

A short barrel tribo gun as described herein in Section II and shown in FIG. 2, was fabricated, in which the interior surfaces of the gun, specifically the interior surface of the powder conduit insert and flat spray nozzle, were made of red peppercorn, melamine formaldehyde, designated Perstorp 775270 from Perstorp Compounds Inc., Florence, Mass. The gun used in the test had two pairs of air jets and two electrodes. The air jets were offset from the centerline which is perpendicular to the longitudinal axis by one jet diameter and the second set of air jets was rotated about the longitudinal axis by 5 degrees relative from the first set of air jets. The angle of the air jets was 90 degrees.

The relative transfer efficiency was determined by spraying a set amount of powder at a target, moving perpendicular to the spray gun at the rate of 10 feet per minute. The powder in the spray gun was an epoxy polyester powder, designated 153W-121 from Ferro Corporation. The results are presented below.

TABLE III

| | | | RELATIVE |
|---|---|---|---|
| | MELAMINE | | TRANSFER |
| | FORMALD. | | EFFICIENCY |
| EXAMPLE NO. | GRADE | POLARITY | % |
| Comparative | Nylon 6/6 | Negative | 79.3 |
| Ex. 8 | Melamine G-9 from | Negative | 80.6 |
| | Atlas Fibre Co. of | | |
| | Skokie, Illinois | | |
| Ex. 9 | Red peppercorn | Negative | 74.3 |
| | melamine Perstorp | | |
| | 775270 | | |
| Ex. 10 | White melamine | Negative | 74.7 |
| | 700 Series Molding | | |
| | Compound from | | |
| | Perstorp | | |

4. Acetal Resins

The acetal resin is a polyoxymethylene engineering thermoplastic polymer. The acetal resin is a homopolymer or a copolymer. The acetal resin is optionally combined with polytetrafluorethylene, polytetrafluoroethylene fibers, and polyethylene, or other polymers or additives. Suitable acetal homopolymers are commercially available under the trademark Delrin® from E.I. DuPont de Nemours & Co., in Wilmington, Del. A suitable example is an acetal homopolymer resin comprising 20% Teflon PTFE fibers, and is commercially available under the trade name Delrin AF. One advantage of this material is that electrical shocks from stored capacitance to operators handling this gun are less with this material than other materials tested.

A suitable modified copolymer resin is an acetal copolymer modified with an ultra high molecular weight polyethylene (UHMWPE) which is commercially available under the trade name Ultraform® N2380X available from BASF Corp., Parsippany, N.J. Another suitable acetal copolymer is commercially available under the trade name Celcon® from the Hoechst Celanese Corp. in Chatam, N.J.

### EXAMPLE 11

A short barrel tribocharging gun as described below in Section II and shown in FIG. 2, was fabricated, in which the interior surfaces of the gun, specifically the interior surface of the insert were made from the acetal polymer Delrin 150 from DuPont.

The powder in the spray gun was an epoxy polyester powder, designated 153W-121 from Ferro Corporation or a polyester/urethane powder, designated 153W-281 from Ferro Corporation. The transfer efficiency was determined as in the Examples 8-10. The results are presented below.

Transfer efficiency results are about 62% for both powders as shown in Table IV. below at a flow rate of 2.5 g/s.

TABLE IV
AVERAGE TRANSFER EFFICIENCY OF
DELRIN SHORT TRIBO GUN

| SAMPLE | AVERAGE TE (%) |
|---|---|
| 153W-121 | 61.9 |
| 155W-281 | 62.3 |

One advantage to these acetal resins is that they are capable of being injection molded, thus making it possible to fabricate a low cost powder spray gun. The Delrin acetal resin relative transfer efficiency results were surprising and unexpected because the Delrin resin does not contain nitrogen atoms, which are typically found in negatively charging materials such as nylon and melamines. It was also discovered that the presence of PTFE fibers in the Delrin acetal resin, such as with the Delrin AF acetal resin, resulted in an increase in transfer efficiency over the Delrin acetal resin.

B. Negative Tribocharging Gun With Unconventional Materials

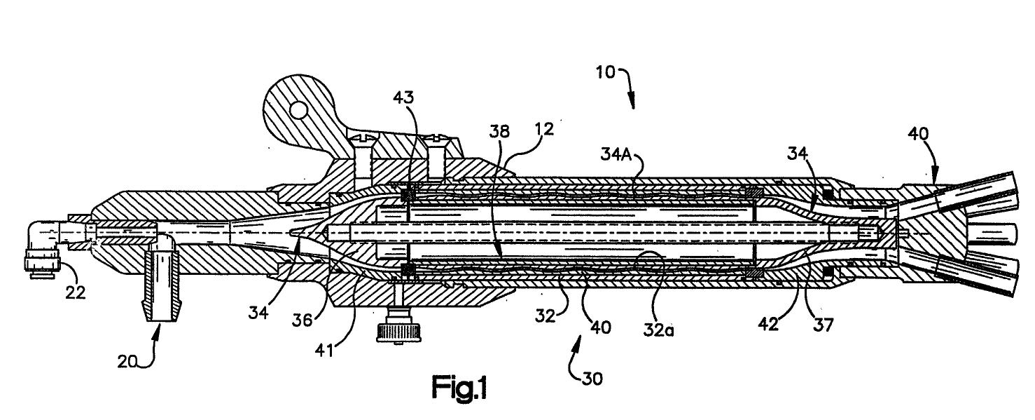

Referring now to FIG. 1, there is shown a tribocharging powder spray gun 10 for use with the method and apparatus of the present inventions. The gun 10 includes a gun body 12 having a central opening extending therethrough. The gun 10 may be supported by a suitable gun mount assembly which is known by those skilled in the art. The gun 10 comprises a powder feed portion 20, a tribocharging portion 30 and a sprayhead portion 40 at the outlet end of the gun.

The tribocharging portion 30 of the gun comprises an inner core 34 positioned within an outer cylinder 32 in which the surfaces 34a, 32a cooperate to provide an annular charging path for the powder flowing through the charging path of the gun. As shown in FIG. 1, the surfaces 34a, 32a may optionally comprise a wavy or undulating surface so that the annular gap provides a tortuous path for the powder, thereby enhancing powder contact with the surfaces 34a,32a so that charge is imparted to the powder.

In the preferred embodiment of the invention, some or all of the powder contact surfaces of the gun are comprised of a material selected from the group consisting of: a polyamide blend, a fiber reinforced polyamide resin, an acetal polymer, an acetal polymer homopolymer, a copolymer, preferably filled with PTFE fibers (hereinafter collectively referred to as acetyl polymer), an aminoplastic resin or mixtures thereof. These are the unconventional negative charging tribo materials of this invention which have been found to charge well. Thus the powder contact surface may be coated with the above mentioned material or the respective component having the powder contact surface may be constructed in whole or in part from the above mentioned materials. Thus as shown in FIG. 1, the powder contact surfaces of the outer cylinder 32, the inner core 34 and the nozzle 40 may be comprised of a material selected from the group consisting of a polyamide blend, fiber reinforced polyamide resin, acetal polymer, aminoplastic resin or mixtures thereof. Additionally, the powder contact surfaces of the inner wear sleeve 38, the outer wear sleeve 40, the inlet wear sleeve 41, the inlet distributor 36, the outlet distributor 37, and the outlet wear sleeve 42 may be coated with or made entirely of a material selected from the group consisting of a polyamide blend, fiber reinforced polyamide resin, acetal polymer, aminoplastic resin or mixtures thereof. Other powder contact surfaces not specifically referenced herein may also comprise the above referenced materials.

A grounded electrode 43, discharge ring or other means know to those skilled in the art (not shown) may be utilized to discharge the powder contact surfaces of the inner core and outer cylinder from the build up of charge. The grounded electrode or discharge ring may be placed in any position known to those skilled in the art.

As shown in FIG. 1, powder and the conveying air is fed to the powder feed portion 20. Powder enters the charging portion of the gun from the feed portion 20 and is channeled into the annular charging path located between the inner core 34 and the outer cylinder 32. As the air entrained powder repeatedly contacts the powder contact surfaces 32a, 34a of the outer cylinder 32 and inner core 34, the powder is tribocharged to a negative polarity. Finally, the tribocharged powder is discharged into the sprayhead portion 40 of the gun. In that unconventional negative charging tribo materials are used, the powder will be negatively charged, but the gun will not experience unacceptable impact fusion of the powder on the charging surface.

II. Short Barrel Tribocharging Powder Spray Gun Constructed From Either Positive Or Novel Negative Tribocharging Materials

As shown in FIG. 2, a first embodiment of the short barrel tribocharging gun 200 of this invention provides a novel powder spray gun of relatively simple construction and small size which charges powder by the tribocharging process. The invention has the advantage of a removable insert 220 which can be easily changed for fast color change of the powder. One important advantage to the short barrel tribogun is that it does not have the disadvantages of strong electric fields or back ionization issues which are present with corona guns. The gun as described in more detail below can positively or negatively charge a powder. The triboelectric powder charging gun, indicated generally at 200, has an overall length in a range of approximately one to ten inches from the powder inlet to the nozzle tip, and more preferably in the range of one to six inches, which is substantially less than the overall length of tribocharging guns of the prior art, which typically run from 14-36 inches in length.

The main components of the gun are a body 210, a powder conduit insert 220 which fits within the body 210, and a nozzle 230 which also fits within or is otherwise attached to the body 210. The insert 220 and nozzle 230 together form the barrel of the gun. The body 210 can be fabricated out of any structurally suitable material. The body 210 has an intake end 212 having an opening adapted to receive an insert 220, and an output end 214 adapted to receive or connect to the nozzle 230. For manual use, a handle or pistol grip (not shown) may be attached to or formed as an integral part of the body 210.

The powder conduit insert 220 is preferably a cylindrical tube having an interior powder passageway 222. The inner diameter of the powder passageway 222 may preferably be in the range of about 0.25 inches to about 1.5 inches, and most preferably is 0.5″.

It is preferred that the insert 220 be removably or releasably connected to the body by conventional methods. For a negative polarity gun, it is preferred that the insert 220 be entirely made of, or have an interior surface 222 coated with, the materials selected from the polyamides, preferably nylon 6/6, a polyamide blend, fiber reinforced polyamide resin, acetal polymer, aminoplastic resin or mixtures thereof. For a positive charging gun, the insert 220 may be entirely made of, or have an interior surface 222 coated with a tribo-charging material such as, but not limited to, fluoropolymers particularly polytetrafluoroethylene, or mixtures thereof. Thus depending upon the type of tribocharging material selected, a negative or positive charge is imparted to the powder particles upon contact with the interior powder contact surfaces of the insert 220.

The spray gun 200 may further comprise one or more air jets 240 which are provided within the interior passageway 222, 234 of the gun. The air jets 240 may be located within the insert 220 or the nozzle 230, and function to create turbulence resulting in the increase of frictional contact of the powder with the walls 222 of the insert 220 or the nozzle 230. Air or other fluid (hereinafter air) is supplied to the air jets 240 via air passage 250 formed in the body 210, which leads to a chamber 252 about the insert 220 or nozzle (not shown). One or more air jets 240 lead from chamber 252 to the powder passageway 222, 234 in insert 220 or nozzle 230 (not shown).

The air jets 240 may comprise any orifice shape such as round, rectangular, square or oval. Each air jet cross-sectional area may range from about 0.001 to about 0.03 square inches (which corresponds to a round hole size of about 0.03 to about 0.2 inches in diameter). More preferably, each air jet cross-sectional area may be in the range of about 0.003 to about 0.005 square inches (which corresponds to a round hole size diameter of about 0.06 to about 0.08 inches). Most preferably, the air jet cross-sectional area may be about 0.0038 square inches, which corresponds to a round hole size diameter of about 0.07 inches.

As shown in FIG. 2, the air jets 240 define an angle ⊖ with respect to the longitudinal axis or insert or nozzle side wall of the internal passageway 222 in the range of about 0 to about 90 degrees, and more preferably in the range of about 45 to about 90 degrees, and most preferably about 60 degrees.

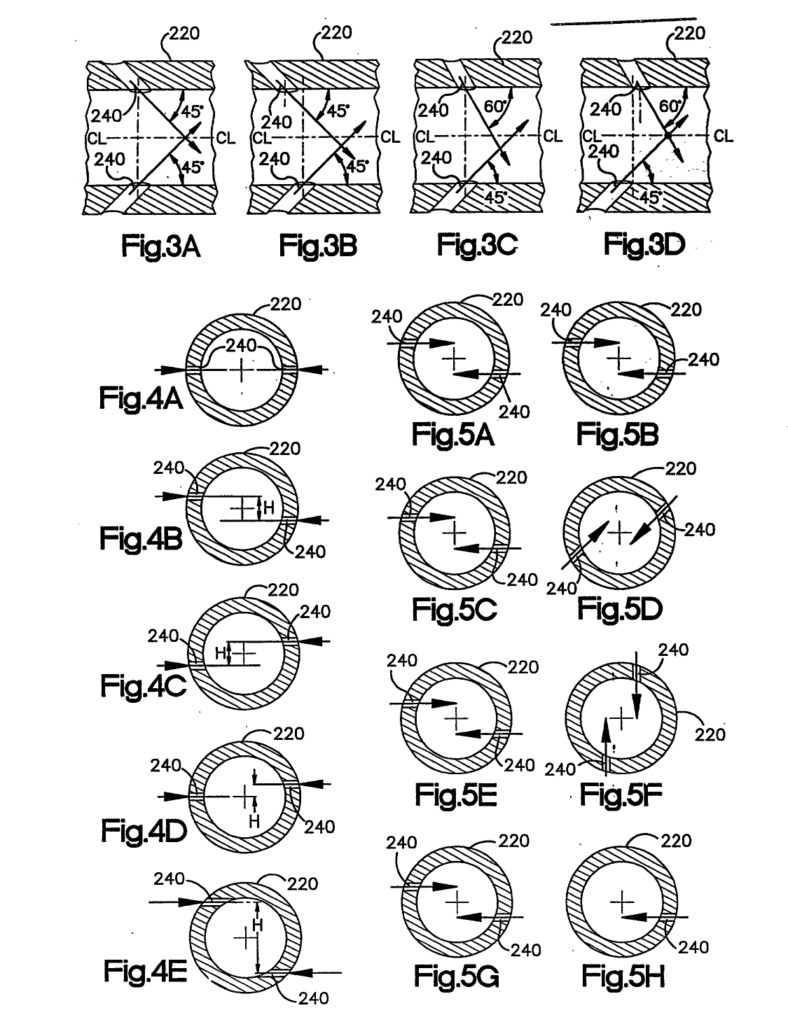

The air jets may be arranged in one or more groups of air jets with the same or differing diameters. A group may be two or more air jets which may be arranged in either an opposed or unopposed configuration. FIGS. 3A-3D illustrate alternate configurations of the arrangements of upper and lower air jets 240 of the insert 220. FIG. 3A illustrates an upper and lower air jet 240 in which the air flow from the jets intersect on the longitudinal axis (or centerline CL). Both the upper and lower air jets form an angle of 45 degrees with the insert sidewall 222. FIG. 3B is almost the same configuration as FIG. 3A except that the center of the upper air jet is longitudinally offset from center of the lower air jet, resulting in the air flow from the air jets intersecting at a point offset from the longitudinal axis. FIG. 3C illustrates that the air jets may have different air jet angles which results in the flow of the air jets intersecting at a point offset from the longitudinal axis. FIG. 3D illustrates that the upper and lower air jets may be longitudinally offset and have different angles yet result in the flow of the jets intersecting at the longitudinal axis.

If two or more air jets are utilized, one air jet may be offset relative to another air jet a distance H perpendicular to the longitudinal axis as shown in FIGS. 4B-4E. Thus, in FIGS. 4B-4E the air jets are vertically offset from one another by varying the perpendicular (or vertical) distances H relative to the longitudinal axis. The distance H may vary from 0 (no offset) as shown in FIG. 4A, to one diameter of the insert as shown in FIG. 4E.

As shown in FIGS. 5A through 5H, if two or more groups of air jets are utilized, one group of air jets may be angularly rotated about the longitudinal axis relative to the first group of air jets in the clockwise or counterclockwise direction. It is preferred that the downstream group of air jets be angularly rotated in the range of about 0 to about 90 degrees relative to the first group in either the clockwise or counterclockwise direction. FIGS. 5A, 5C, 5E and 5G each illustrate a first or upstream group of air jets located within the insert 220 of FIG. 2. FIGS. 5B, 5D, 5F and 5H, represent a second or downstream group of air jets which are rotated 0, 45, 90 and 0 degrees in the counter-clockwise direction with respect to the corresponding first set of air jets of FIGS. 5A, 5C, 5E and 5G, respectively. FIG. 5H also illustrates that the second group of air jets need only comprise one air jet.

The total air flow to the four air jet orifices 240 in FIG. 2 may range from about 0.3 cubic feet per minute (CFM) to about 6.5 cubic feet/minute. If two pairs of air jets are utilized, the total air flow rate to the air jets is preferably 4.2 CFM. The air jet orifices 240 typically have an air velocity in the range of about 100 to about 1,000 feet/second, and more preferably in the range of about 400 to about 800 feet/second, and most preferably about 655 feet/second. These variables can be scaled appropriately for different diameter tubes.

The internal charging gun 200 is further provided with one or more electrodes 260 or other means known to those skilled in the art which function to discharge the tribocharging surfaces 222, 234 due to the build up of charge as a result of frictional contact with the powder. For example, the electrode may be a conductive pin, a pressed solid metal ring, an air washed porous ring, or a metal strip located along the longitudinal axis inside the charging tube. The one or more electrodes are preferably electrically grounded. However, the electrode 260 may also be charged to either a positive or negative electrical potential as shown in FIG. 2, preferably in the range of about 0 to about 10 kilovolts (kv). The electrode 260 may be positioned within the interior of the insert 220 or the nozzle 230, however it is preferred that the electrode be positioned upstream from the air jets. The one or more electrodes 260 may be airwashed, i.e., an air flow is provided from chamber 250 through passages 262 and 264 to blow powder off of the electrode 260.

A flat spray nozzle 230 is shown in FIG. 2 in conjunction with the invention, although other prior art nozzles would also work for the invention. The nozzle 230 has a slot 232 which creates a generally flat spray pattern, and an interior passageway 234 which is in fluid communication with the interior passageway 222 of the insert 220. It is preferred that the nozzle 230 be removably or releasably connected to the gun body 210 by any conventional methods. Because the nozzle is a high powder contact area, for a negative tribo charging gun, it is also preferred that the nozzle 230 be entirely made of, or have an interior surface 234 coated with a tribo-charging material such as a polyamide, particularly nylon 6/6, a polyamide blend, fiber reinforced polyamide resin, acetal polymer, aminoplastic resin or mixtures thereof. For a positive tribo charging gun, it is also preferred that the nozzle 230 be entirely made of, or have an interior surface 234 coated with a tribo-charging material such as fluoropolymers particularly PTFE. Thus depending upon the type of tribocharging material selected, a negative or positive charge is transferred to the powder particles upon contact with the interior surface 234 of the nozzle 230. Thus the nozzle 230 works in conjunction with the insert 220 to tribocharge the powder particles to the desired polarity as they contact the inner surface of the gun 200.

Although not shown, the insert 220 and nozzle 230 may be formed as an integral one piece unit which is releasably connected to the body 210 (not shown). Alternatively, the insert 220 and nozzle 230 may be releasably connected together and then releasably connected to the body. Thus, a particular advantage of the short internal charging gun 200 of the invention is the simple configuration of the insert 220 and nozzle 230, which allows these components to be fabricated out of, or coated with any of the described tribocharging materials and easily interchanged with the gun body 210. An array of inserts 220 and nozzles 230, made of or coated with different tribocharging materials, can be provided for use with a single gun body. An appropriate insert and nozzle can then be selected according to the type of powder to be sprayed, and according to the type of polarity to be applied to the powder. Since powders charge differently from one another depending on their chemistry, a material-specific insert can be used for a particular powder chemistry. For example, epoxies tend to charge positively, so a PTFE insert would be ideal for this powder. Polyesters, on the other hand, tend to charge negatively, and would therefore be charged better using a nylon insert.

The following examples illustrate several gun configurations having varying placement of air jets, type and position of electrodes and use of tribocharging materials. However, the invention is not limited to these examples, as many other combinations and configurations are possible.

### EXAMPLE 12

In one example of the invention, a tribocharging gun 200 having an insert 220 was fabricated out of nylon 6/6 material. The insert had two pairs of aligned, opposed air jets, with each air jet angled in the insert sidewall at an angle 0 of 60 degrees, and having a velocity of about 655 feet/second and a total air flow rate of 4.2 cubic foot/minute. The centerline of the first pair of air jets is longitudinally spaced 0.625″ apart from the centerline of the second pair of air jets. A grounded electrode was mounted flush with the internal surface of the powderflow passageway and was angularly offset from the air jets by 60 degrees. The gun was 5.75 inches long as measured from the powder inlet to the tip of a flat spray nozzle. The powder flow rate was 20 lbs/hr using Ferro 153W-108 polyester urethane powder. The transfer efficiency for this configuration was 78.0%.

### EXAMPLE 13

In another example of the invention using the same gun configuration as described in Example 12, the electrode was charged to −8 KV. The transfer efficiency was measured at 84%.

### EXAMPLE 14

In another example of the invention, a short barrel tribocharging gun was fabricated out of Delrin 100 AF material. The total combined length of the insert and nozzle was 3.375 inches. A 4 mm Delrin 100AF flat spray nozzle was used. As shown in FIG. 2, the insert inlet diameter was 0.375 inches for a length of 1.25 inches, and was followed by a 45 degree step opening the insert diameter to 0.5 inches for the remainder of the tube length of 2.125 inches. Two pairs of opposing air jets were used, with each air jet having a diameter of 0.07 inches, and having an angle ⊖ of 60 degrees. The downstream set of air jets was rotated about the longitudinal axis by 5 degrees relative to the first pair of air jets. All of the air jets were offset a perpendicular distance from the longitudinal axis by 0.035 inches. Each air jet had an airflow rate of about 1 standard cubic feet per minute and a velocity of 655 ft/sec. A single grounded sharp tipped electrode was located upstream from the air jets as shown in FIG. 2. The electrode was angularly rotated about the longitudinal axis by 60 degrees relative to the first set of air jets. The transfer efficiency for this configuration was 70% using Ferro 153W-121 at 20 lbs/hour.

In summary, the above described short barrel tribocharging gun provides a novel lightweight spray gun which is easily maneuverable into tight spaces due to the guns shorter length and smaller diameter. Conventional tribcharging guns are typically 14-36 inches in length, while the short tribocharging gun provides a gun of about 6 inches long. The gun lends itself as a manual gun or use as a low cost automatic gun. The straight flow powder path allows for easy cleaning, as well as a removable insert which can be easily replaced by an inexpensive insert for quick color changes. The novel materials which are used to make the gun are injection moldable, thus reducing the machining costs significantly. Thus the invention provides a short barrel tribocharging gun which can accommodate a powder flow rate of up to about 30 lbs/hour and a reasonable transfer efficiency.

The invention further provides a short barrel negative tribocharging gun which can be used alone or in conjunction with a negative corona gun as described in more detail below. While providing all of the above described advantages, the short barrel negative tribocharging gun further provides the advantage of excellently applying and charging polyester powders such as TGIC polyesters, epoxy/polyester hybrid powders, and polyester urethanes, as well as thermoplastic powders such as PVC and PTFE powders.

III. Unipolarity Corona Gun With Tribo-Charging Components

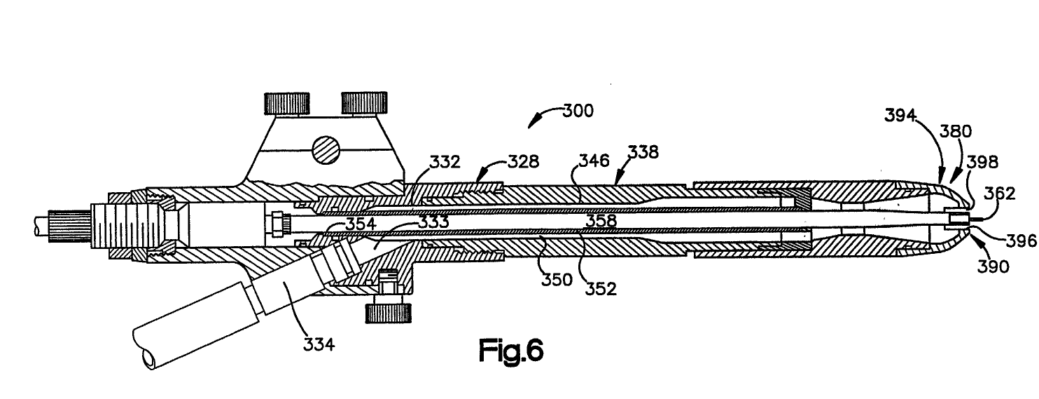

Referring now to FIG. 6, a unipolarity corona spray gun 300 is provided for spraying fluidized powder that has been charged to either a positive or negative polarity. The term “unipolarity” refers to a powder spray gun or powder supply system wherein the components are selected to charge the powder coating material to a single polarity. An example would be a corona gun with a negative polarity power supply which includes tribocharging components such as the spray nozzle which also charges the powder negatively. The gun 300 comprises a rearward barrel 328 which may be secured to a mounting block. The rearward barrel 328 has an internal bore 332 and an angled bore 333 for connection to a powder supply tube 334. The powder supply tube 334 functions to introduce fluidized powder through the angled bore 333 into the throughbore 332 of the rearward barrel member 328. The forward end of the rearward barrel member 328 is connected to a forward barrel member 338, which further comprises a throughbore 346 which is axially aligned with bore 332 to form a powder flow passageway 350 for transferring powder from the powder supply tube 334 towards the forward end of the gun 300. A flat spray nozzle 394 is located on the forward end of the forward barrel member 380.

A barrel liner 352 extends axially within the powder passageway 350 which is mounted within the end of the rearward barrel member 328. The barrel liner 352 receives and supports a high voltage electrostatic cable assembly 358. An electrode 362 is mounted at the forward end of the cable assembly 352 and extends through a bore 396 of the of the nozzle tip 390 and extends forward of the spray nozzle 394 between the rectangular slot 398. The electrode 362 extending forward of the spray nozzle 380, produces a strong electrostatic field between it and the object to be coated. The electrode may be charged positively or negatively depending upon the desired gun polarity. It is preferred that the electrode be charged to the desired polarity in the range of about 60 to about 100 kv.

The powder contact surfaces of the corona gun 300 are the barrel liner 352, the powder passageway 350, the powder supply tube 334, and the passageway 372 through nozzle 380. For a positive polarity corona gun which charges the powder to a positive polarity, one or more powder contact surfaces 334, 350, 352, or 372, for example, are comprised of materials which tribocharge the powder positively. These materials are selected from the group consisting of: polyethylene, a fluoropolymer or mixtures thereof. It is preferred that the fluoropolymer comprise polytetrafluoroethylene. For a negative polarity corona gun which charges the powder to a negative polarity, one or more of the powder contact surfaces 334, 350, 352, or 372, for example, of the corona gun 300 are selected to be of a material which tribocharges the powder negatively. These surfaces are comprised of a material selected form the group consisting of: a polyamide, a polyamide blend, a fiber reinforced polyamide resin, an acetal polymer, an aminoplastic resin or mixtures thereof, as described in detail in Section I.

Thus the unipolarity corona gun of the present invention utilizes tribocharging to charge the powder as well as the corona charging. The tribocharging which occurs is of the same polarity as and therefore increases the charge on the powder which results from the corona charging electrode. Because the powder contact surfaces add to the charge on the powder produced by the corona electrode, less electrode voltage is needed to produce the same amount of charge as in prior art guns. Thus for a negative polarity gun, reduced back ionization occurs because the voltage is lower. This results in an improved surface finish. This reduction in electrode voltage also reduces the Faraday Cage effect. In addition, a smaller power supply can be used to produce the same voltage.

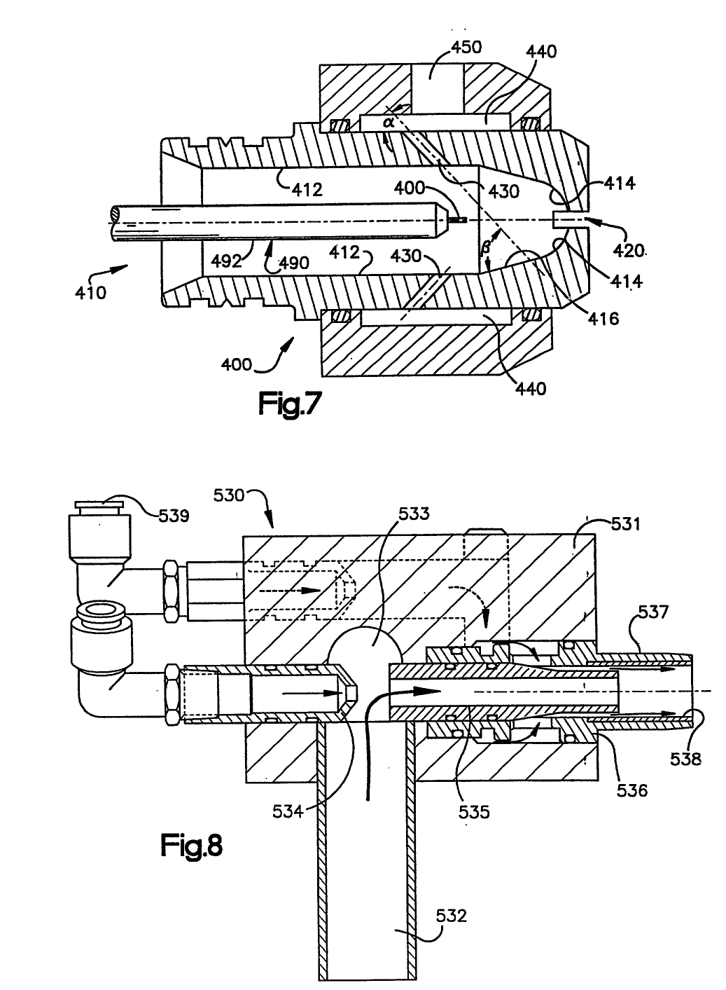

In an alternate embodiment of the invention, the corona gun 300 may additionally include an enhanced tribocharging nozzle 400 as shown in FIG. 7. Tribocharging nozzle 400 may be used with other prior art corona or tribocharging guns and is not limited to the corona gun 300 as described above. Tribocharging nozzle 400 provides a large interior surface area which may be utilized in order to tribocharge the powder. The powder may be charged positively or negatively as desired depending upon the triboelectric material selected, as described in more detail, below.

The nozzle shown generally at 400 has a powder inlet end 410 and an interior flow passageway 412 which is in fluid communication with the interior passageway of a prior art corona gun or triboelectric gun (not shown). The inlet end 410 may be threaded or otherwise configured to be releasably connected to the body of a prior art spray gun. The interior passageway 412 is preferably cylindrically shaped with a transition surface 414 leading to the nozzle slot 420. The nozzle 400 has a slot 420 shaped to create a generally flat spray pattern. The depth and width of the nozzle slot 420 may be sized as needed for the particular application.

Because the nozzle surfaces 412, 414 are in contact with the powder, it is preferred that the nozzle 400 be entirely made of, or have an interior surface coated with a tribo-charging material. For a positive polarity corona gun, it is preferred that the nozzle be made or have interior powder contact surfaces coated with a material selected from the group consisting of: fluoropolymers particularly PTFE. For use with a negative polarity gun, it is more preferable that the nozzle 400 be entirely made of, or have interior surfaces 412, 414 coated with the materials selected from the group consisting of: a polyamide, particularly nylon 6/6, a polyamide blend, a fiber reinforced polyamide resin, an acetal polymer, an aminoplastic resin, or mixtures thereof. Thus depending upon the type of tribocharging material selected, a negative or positive charge is transferred to the powder particles upon contact with the interior surfaces 412, 414 of the nozzle 400. Thus the nozzle 400 can work in conjunction with the corona charging electrode of the prior art spray guns in order to charge the powder with the same polarity as the corona electrode.

The nozzle 400 may preferably include one or more air jet orifices 430 which are positioned for fluid communication with the internal passageway 412 of the nozzle. Air or other fluid is provided to the air jet orifices 430 for example by chamber 440 which is connected to an external fluid source (not shown) via port 450. It is preferred that the air jet orifices 430 be sized and configured to provide an air velocity in the range of about 100 to about 1,000 feet/second, and more preferably in the range of about 400 to about 800 feet/second. It is additionally preferred that the air jet orifice(s) 430 comprise an angle α with respect to the longitudinal axis of the insert internal passageway in the range of about 0 to about 90 degrees, and more preferably in the range of about 45 to about 90 degrees. It is preferred that the angle of the air jet orifices 430 be such that the air jets intersect to provide turbulence resulting in increased frictional contact with the charging surface. It is preferred that the impact angle β of the air jets upon the transition surface 414 should be in the range of about 45 to about 90 degrees, and more preferably about 60 degrees.

The nozzle 400 may additionally comprise one or more electrodes 460 or other means known to those skilled in the art to discharge the interior surface 412 from charge build-up. The one or more electrodes is preferably grounded. Alternatively, the one or more electrodes may have a positive or negative charge in the range of about 0 to about 100 KV, and more preferably in the range of about 0 to about 10 kv. The high voltage electrode(s) is charged positively if an electronegative charging material is utilized, and the electrodes are charged negatively if an electropositive charging material is utilized on the interior surface of the nozzle. As shown in FIG. 7, the electrode may be positioned within an electrode holder 490. The electrode holder 490 has an outer surface 492 made of the materials described for the internal passageway 412 of the nozzle described above. However, it is important to note that other electrode configurations are possible such as for example, a ground ring, or a blunt or sharp tipped conductive pin. If a conductive pin is used, it may be positioned at a right angle to the fluid passageway anywhere in the nozzle 400. The electrodes are positioned upstream within about 2 inches of the air jet impingement on the wall.

In a preferred embodiment of the nozzle, the electrode is grounded and positioned upstream of 2 pairs of aligned, opposed air jets which are laterally spaced one diameter apart. The air jets are angled at 60 degrees with respect to the longitudinal axis.

IV. Tribo-Charging Components of Powder Delivery Systems

The invention further provides tribocharging powder contact surfaces in various components throughout a powder delivery system which can be used to tribocharge the powder to the same polarity as the corona powder supply. Tribocharging at several areas along the delivery system incrementally increases the charge on the powder as it passes through each tribocharging area. This benefits corona gun systems with increased transfer efficiency. This idea can also be used with tribocharging gun systems. The tribocharging areas of the powder supply system tribocharge the powder to the same polarity as is used in the triboguns of the system.

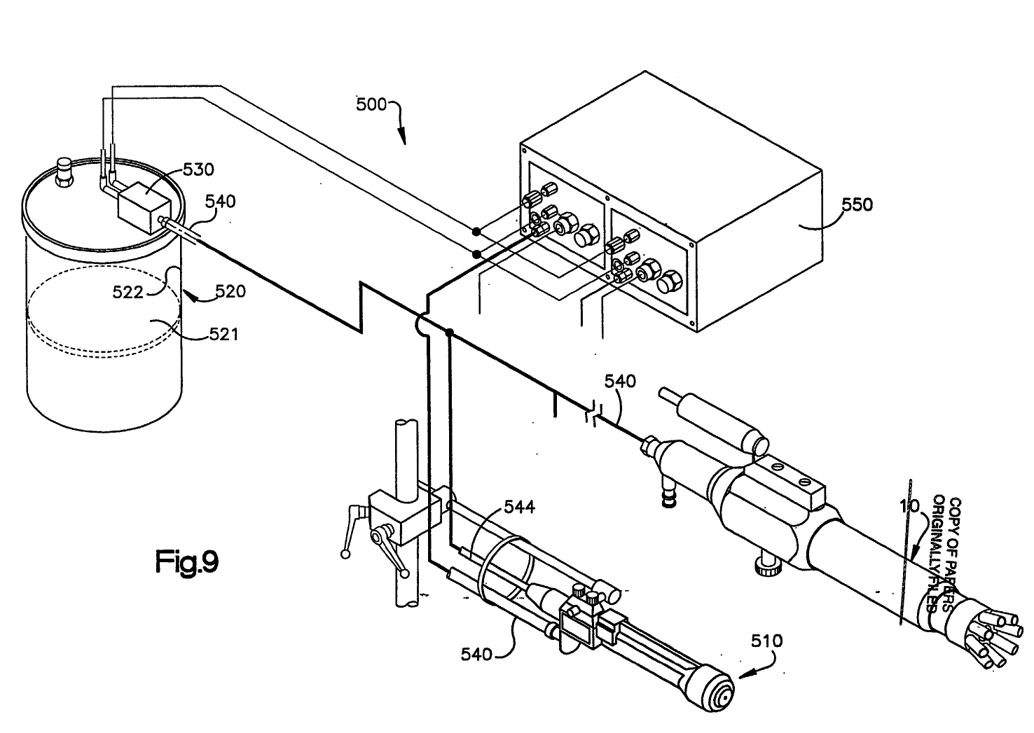

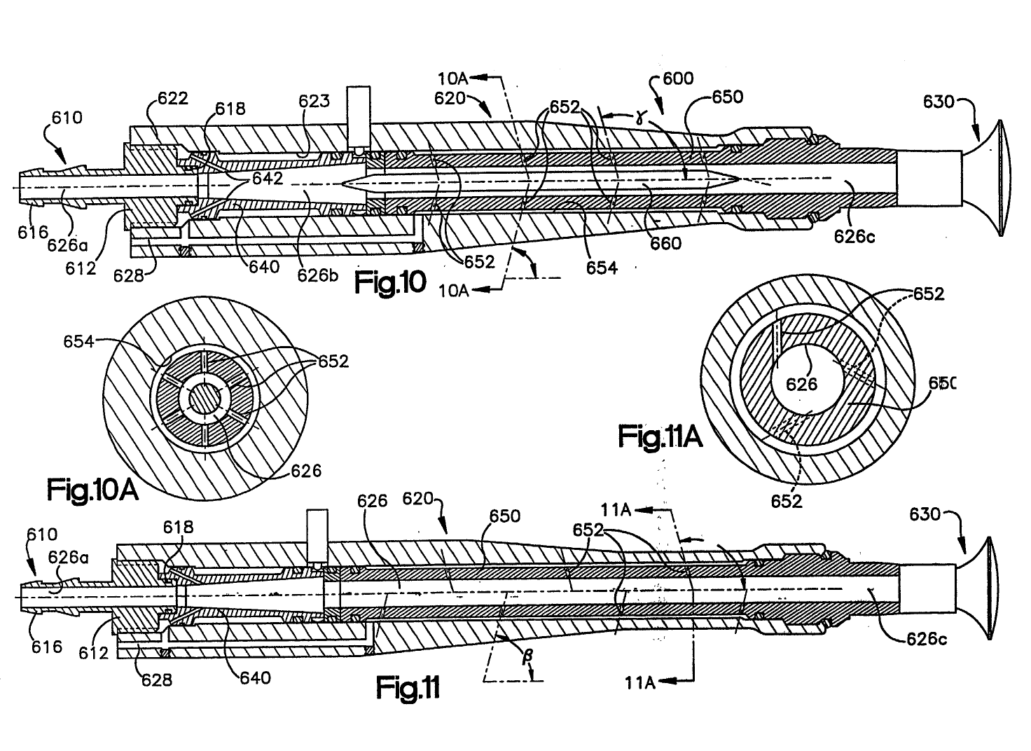

As shown in FIG. 9, a typical powder spray system 500 includes a spray gun 510 connected by a powder supply hose 540 to a hopper 520, through a powder pump 530 mounted on top of the hopper. The spray gun 510 is, for example a negative charging corona type powder spray gun, but may alternatively be a positive charging corona gun, or a negative or positive tribo-charging powder spray gun.

An electrical line 544 is connected to the gun 510 from control system 550 which regulates air pressure to pump 530 and the voltage of the corona electrode in gun 510. Within the powder hopper 520, a diffuser plate 521 is configured to extend over a cross-sectional area within the hopper, and is formed of a porous material through which air passes to fluidize the powder. Because the hopper sidewalls 522 and the diffuser plate 521 are high contact areas of the powder, the invention includes constructing the plate 521 and sidewalls 522 out of the negative tribo pre-charging materials selected from the group consisting of polyamides, particularly nylon 6/6, a polyamide blend, fiber reinforced polyamide resin, acetal polymer, aminoplastic resin or mixtures thereof. Thus contact of the powder with the diffuser plate 521 and sidewalls within the hopper 520 pre-charges the powder negatively before it is transported to negative corona gun 510.

The pump 530, shown in cross-section in FIG. 8, includes a body 531 with a powder inlet tube 532 leading to a cavity 533 which is intersected by an ejector or venturi nozzle 534 and a venturi throat 535. The venturi throat 535 is held in the pump body 531 by a throat holder 536 which extends out of the pump body to provide an attachment fitting 537 for a hose. Within the attachment fitting 537 is a wear sleeve 538, also referred to as a wear tube, downstream of the pump throat. The wear sleeve prevents impact fusion on the inside wall of the throat holder. An atomizing air inlet 539 intersects with the throat holder 536 to provide air flow which joins the powder air mixture from the venturi throat.

This area in the powder delivery system is thus a suitable site for use of one of the described pre-charging materials. Thus it is desired that the venturi throat 535, wear sleeve 538, pump suction tube 532, and powder hose (not shown) be coated with or fabricated from the materials selected from the group consisting of a polyamide, polyamide blend, fiber reinforced polyamide resin, acetal polymer, aminoplastic resin or mixtures thereof, as described in more detail above, to precharge the powder triboelectrically with a negative polarity. It is additionally preferred that the length of the venturi throat 535 and the throat holder 536 be extended by, for example, from one to five inches beyond the edge of the pump body. Optimally, this extended length provides for substantial additional negative tribocharging of powder at this region of the powder delivery system.

Powder pre-charged in the powder delivery system in the hopper and/or pump as described in this section flows through the hose to arrive at the gun with a pre-established negative charge. This pre-charging augments the additional negative charge applied at the gun by the corona electrode.

V. Unipolarity Powder Coating System Including Corona and Tribocharging Guns

As shown in FIG. 9, a corona gun 510 is shown together in use with a tribo-charging powder spray gun 10 of the invention, which has been described in detail, above. The corona gun 510 and the tribocharging gun 10 have the same polarity. This unique combination allows for the tribocharging gun 10 to be used as a touch up gun, for example, to penetrate the corners or hard to reach parts that the corona gun 510 has not effectively coated. This exemplary combination of a negative corona gun 510 and a negative tribo-charging gun 10 is preferably connected to a common powder delivery system 520, which pre-charges the powder negatively as described above. Alternatively, the tribocharging gun may comprise the short barrel gun 200 (not shown) which is described in more detail, above. This novel combination of one or more negative corona guns with one or more negative tribo guns, optimally with a negative pre-charging powder delivery system, used to coat different parts of the same workpiece is one important embodiment of this invention.

VI. Tribocharging Gun With Air Jets

As shown in FIG. 10, a novel tribocharging gun 600 is provided which comprises a powder feed section 610, a powder charging section 620, and a spray nozzle 630 located at the outlet of the gun. The powder charging section 620 of the tribocharging gun 600 further comprises a cylindrically shaped body 622 having an internal bore 623 for housing the internal components of the gun. Housed within the bore 623 of the body 622 is a powder tube connector 612 having an internal bore 626a. A first end 616 of the connector 612 is connected to a powder supply tube (not shown) for supplying fluidized powder to the powder flow passageway 626a,b,c of the gun 600. The second end 618 of the powder tube connector 612 is connected to an inlet air entry 640. The inlet air entry 640 has an internal passageway 626b and one or more angled holes or air jets 642 which are connected to an air manifold 628 located in the body 622 for supplying pressurized air to the air jets 642 in order to increase the velocity and induce turbulence of the fluidized powder entering the gun. Connected to the inlet air entry 640 is an outer wear tube 650 which has an internal passageway which is part of the powder flow passageway 626 of the gun. The outer wear tube 650 further comprises one or more air jets 652. Pressurized air is provided to the air jets 652 via passageway 654 which is in fluid communication with air manifold 628. The gun 600 may further be provided with an optional inner wear surface 660 which forms an annular powder flow path. As shown in a cross sectional view in FIG. 10A, a plurality of air jets 652 are arranged in an opposed configuration at one or more longitudinal stations. Preferably the air jets 652 comprise an angle γ ( as measured counterclockwise from the longitudinal axis) preferably in the range of about 90 to about 135 degrees. The air jet velocity is preferably high enough to induce turbulence and cause the powder flowing through passageway to contact the wall opposite the air jet, in order to increase the tribocharging of the powder. It is preferred that the air jet velocity be in the range of about 100 to about 1,000 feet/second and more preferably in the range of about 400 to about 800 feet/second.

In order to provide tribocharging of the powder, the powder contact surfaces of the gun such as the internal surface of the powder flow passageway 626a-c, the nozzle 630 and the outer surface of the inner charge tube 660 are constructed from or coated with a tribocharging material. For a positive polarity tribocharging gun the powder contact surfaces are preferably selected from the group consisting of: fluoropolymers particularly PTFE. For a negative polarity tribocharging gun the powder contact surfaces are preferably selected from the group consisting of: nylon, particularly nylon 6/6, a polyamide blend, a fiber reinforced polyamide resin, an acetal polymer, an aminoplastic resin or mixtures thereof.

In yet another embodiment of the invention as shown in FIG. 11, the tribocharging gun is the same as described above, except for the following differences. First, no inner charge tube 660 is utilized. Second, the air jets 652 of the tribocharging gun 600 located within the outer wear tube 650 are arranged in a helical pattern about the longitudinal axis as shown in FIGS. 11 and 11A. Optionally, the air jets 652a located on the upper portion of the tube 650 can have a different angular orientation than the air jets 652b located on the lower portion of the tube 650 (not shown). The air jets 652a, 652b when configured in this manner, are designed to impact the fluidized powder against the opposite wall in a staggered or wave fashion in order to increase the tribocharging of the powder. It is preferred that there be 3-4 sets of holes arranged in the configuration, with each set comprising 2 or more holes. This helical configuration functions to induce turbulence and swirl the fluidized powder in a helical fashion so that the relatively heavier powder is spun or induced to impact the wall via centrifugal forces into contact with the passageway wall.

An advantage of this embodiment is that to cause each powder particle to impact the charging surface numerous times and thereby increase the charge on the powder, instead of forming mechanical waves on the charging surface such as shown in the FIG. 1 gun, the charging surface is a straight cylinder which is easy to manufacture, while the air jets 652 cause the powder particles to take a turbulent route through the flow passage 626a,b,c, impacting the surface many times to increase the triboelectrically induced charge on the powders.

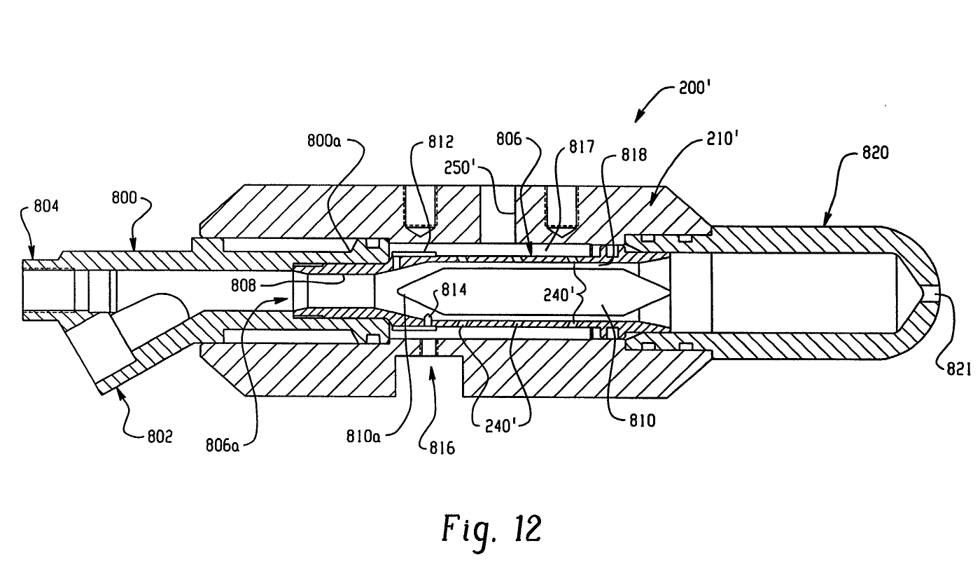

With reference to FIG. 12, another embodiment of the short barrel tribocharging gun 200 of FIG. 2 is illustrated. In the embodiment of FIG. 12, the modified gun 200′ includes a gun body 210′ that retains a powder conduit insert 800 that is somewhat different from the insert 220 in FIG. 2. The insert 800 includes a powder feed inlet 802 and an optional diffuser air inlet 804. Diffuser air may be used as required to increase the velocity of the powder through the gun 200′. This increased velocity increases the tribocharge charging effect on the powder, and also helps diffuse the powder, and also may be used to affect the spray pattern. Diffuser air however is not required in all situations, and depends on several factors among which are notably the velocity and pressure of the powder entering the gun 200′ from the powder supply hose 540 and related powder supply components (see FIG. 9 and the discussion herein related thereto) as well as how much additional diffusion of the powder is required, if any, through the gun. In many cases where the air jets are incorporated into a tribocharging type gun, the pressure drop created by the air flow through the air jets may be sufficient to obviate the use of diffuser air. This is particularly the case when the air jets are forwardly angled to direct a significant air flow in the axially forward direction through the gun, thereby inducing a suction effect at the powder inlet end of the gun. Reducing overall air use in a spray gun is usually beneficial as it reduces operating costs associated with shop air, impact fusion and wear. Reducing impact fusion helps speed up color change and cleaning operations.

The inner end 800a of the powder conduit insert 800 slideably receives a first end of a charging tube 806. The charging tube 806 is preferably made of any one of the various materials described herein to apply either a positive or negative charge to the powder as desired for a particular application. The charging tube inlet 806a may include an optional internal diametric reduction or neck down 808 which serves to increase powder velocity (without needing to increase diffuser air volume or pressure) and also to re-center the powder in the central volume of the charging tube 806 before the powder enters the main portion of the charging tube.

A solid or hollow shaft 810 is longitudinally and preferably coaxially positioned within the charging tube 806. This shaft 810 is preferably but not necessarily cylindrical in shape, and includes an optional taper to a conical end 810a to facilitate discharge of the shaft 810. The charging tube 806 includes a metallic discharge or grounding ring 812 that is connected to a grounded discharge pin 814. The pin 814 permits the charging tube 806 and the shaft 810 to self-discharge during a spraying operation as charge builds up on the tribocharging surfaces. A bore 816 is provided to receive a grounded pin or wire (not shown) that contacts the grounding ring 812.

The body 210′ includes an air inlet port 250′ much in the same manner as the port 250 in the embodiment of FIG. 2 herein. This port 250′ opens into an annulus 817. The annulus 817 is in fluid communication with and surrounds another annulus 818 that is generally defined by the space between the outer circumference of the shaft 810 and the inner surface of the charging tube 806. The annulus 818 preferably forms a rather narrow gap between the charging tube 806 and the shaft 810. A series of air jets 240′ are provided through the wall of the charging tube 806, in a manner similar to the embodiment of FIG. 2 herein, and pressurized air flows from the outer annulus 817 to the inner annulus 818 therethrough. The exact location, number, angle and orientation of the jets 240′ may be determined based on various factors as previously described herein. In accordance with one aspect of the invention, the smaller annulus 818, as compared, for example to the diameter of the tubular insert 220 in FIG. 2, significantly reduces the travel distance for powder particles that are forced by air from the jets 240′ toward the shaft 810. Thus, less air is required to cause the powder to impact the tribocharging surface of the shaft 810 at a comparable velocity to the embodiment of FIG. 2. This not only reduces the air requirements, but also reduces impact fusion effects. Additionally, use of the shaft 810 substantially increases the total surface area of tribocharging material to which the powder particles are exposed, because the powder will impact both the surface area of the shaft 810 as well as the inner surface area of the charging tube 806. The air jets 240′ may be angled forwardly and radially as in FIG. 12 (relative to the longitudinal axis of the gun 200′) or may also be offset to create a spinning air movement around the shaft 810, as previously described herein. The narrower annulus 818 also permits conventional tribocharging effects on the powder as it passes through the gun 200′, much in an analogous manner that a prior art tribocharging gun uses a tortuous or wavy path for the powder to pass through. By way of example, the annulus 818 may vary from about 0.02 inches to about 0.5 inches, although the exact dimensions selected will depend on the overall performance characteristics and requirements of each gun design.

The shaft 810 is positioned and held in the charging tube 806 by any convenient mechanism, such as for example centering pins (not shown). Furthermore, in the embodiment of FIG. 12, the insert 800, the charging tube 806 and the nozzle 820 form the gun barrel and may all be made of the various materials described herein to produce positive or negative charging of the powder particles as desired, as will the shaft 810 be made of such tribocharging materials. The embodiment of FIG. 12 uses a conventional flat spray nozzle 820 having a slot 821 but any suitable nozzle design may be used.

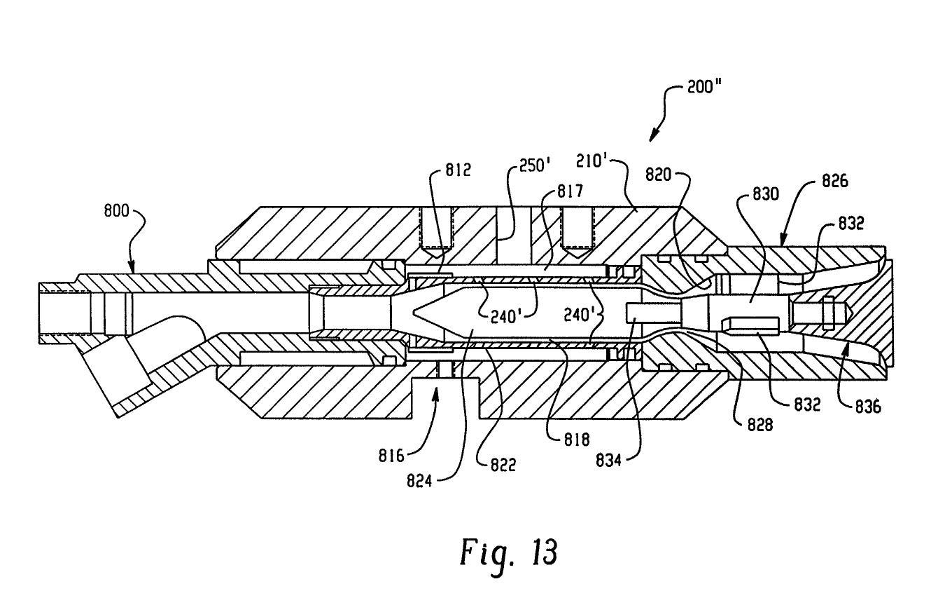

With reference to FIG. 13, an alternative embodiment of the FIG. 12 version is illustrated. Like parts are given like reference numerals and the description thereof is not repeated. In the embodiment of FIG. 13, the charging tube 822 and the shaft 824 have been modified at their forward ends to cooperate with a corresponding configuration of a nozzle body 826 to define a tribocharging parallel wave path 828 that is downstream of the annulus 818. The wave path 828 is realized in the form of an hourglass type reduced diameter in the nozzle body cavity 820. The shaft 824 is formed with a corresponding geometry, and the charging tube 822 forward end simply abuts the backward end of the nozzle body 826 to form a smooth continuous contour. A spider 830 is centered and supported in the nozzle body 826 cavity by a plurality of radial legs 832. The spider 830 may be joined or assembled with the shaft 824 if so required, by a pin insert 834, and at its forward end the spider 830 may be used to support a conventional conical nozzle 836. The spider 830 preferably is made of a suitable tribocharging material such as those described herein. In this embodiment then, the gun 200″ operates with both the air jets 240′, the charging tube 822 and the shaft 824 initially charging the powder, as well as a tribocharging post-charge function produced by the parallel wave path 828. Although in the embodiment of FIG. 13 the tribocharging section 828 is illustrated as a parallel wave pattern, such illustration is intended to be exemplary in nature and should not be construed in a limiting sense. Those skilled in the art will readily appreciate that the tribocharging section may be realized utilizing any number of known tribocharging arrangements.

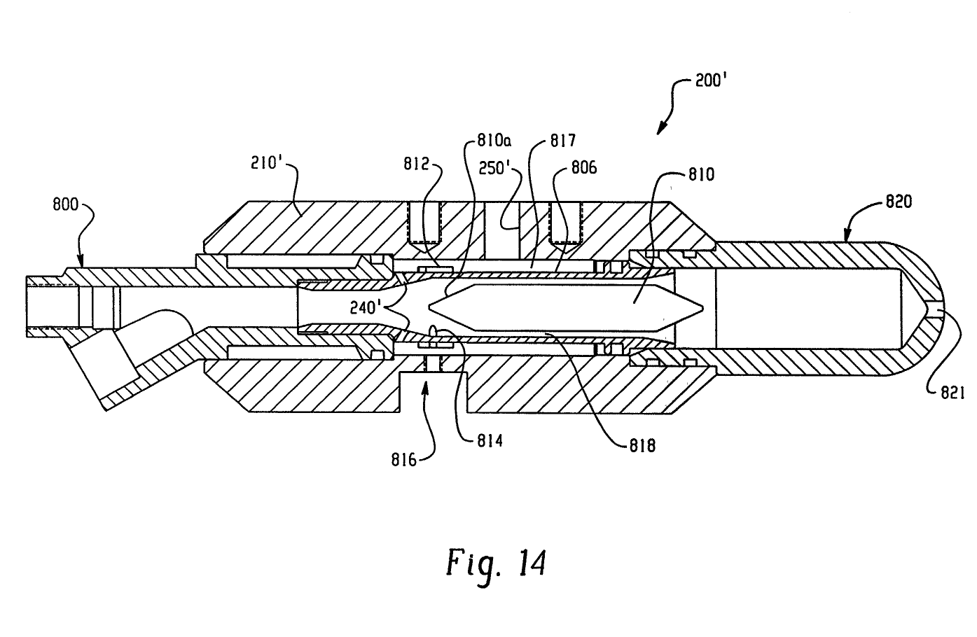

FIG. 14 illustrates another modification of the gun 200′ in FIG. 12. In this version, the shaft 810 is installed in a slightly axially forward position as compared to the shaft 810 in FIG. 12. This has the effect of positioning the conical rearward tip 810a of the shaft 810 nearer the grounding pin 814. This significantly increases the ease with which the shaft 810 may discharge during a spraying operation.

FIG. 14 further includes the concept of incorporating both an initial air jet assisted or induced tribocharging function and an additional tribocharging function into the gun 200′. Note in FIG. 14, as compared for example to FIG. 13, that the air jets 240′ are positioned aft of the shaft 810. This places the air jet induced tribocharging function first, followed by a subsequent tribocharging function in the annulus 818. The air jets apply sufficient energy to the powder particles to cause impact against the charging tube and shaft surfaces to charge the powder. The air flow produced by the air jets is sufficient to allow a tribocharging effect downstream via the annulus 818 without needing a tortuous, wavy or other conventional tribocharging path, although such tribocharging techniques and configurations may be used if so required.

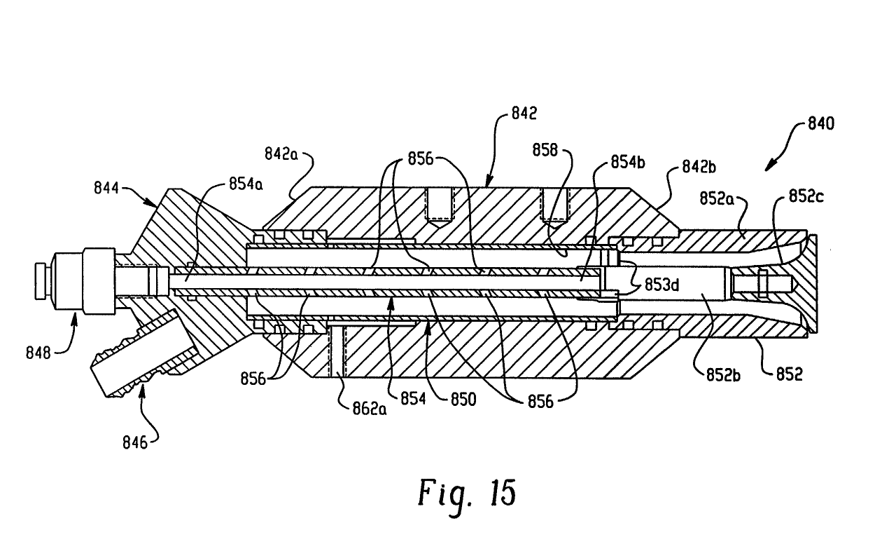

With reference next to FIG. 15, another gun embodiment is illustrated. The basic concept illustrated in this drawing is referred to herein as an “inside-out” gun because, as compared to the embodiments previously described herein, the flow direction of the air jets is reversed. Thus the prior embodiments herein can for convenience be referred to as “outside-in” gun configurations. In the embodiment of FIG. 15 then, the gun 840 includes a gun body 842 that has a rearward end 842a and a forward end 842b. The rearward end 842a includes a counterbore that slideably receives and retains a powder conduit insert 844. The powder insert 844 supports a powder tube connection nipple 846 and an air inlet connector 848. The insert 844 receives and supports a first end of a charging tube 850 that is made of a suitable tribocharging material as previously described herein. The charging tube 850 extends through the gun body 842 to a nozzle assembly 852. The particular design of the nozzle assembly 852 may be selected as required for a specific spray pattern. In the example of FIG. 15, the nozzle assembly 852 includes a nozzle body 852a that retains a spider 852b which at one end supports a conventional conical nozzle 852c. The spider 852b may include radial legs 852d or other suitable elements to such as pins to support the spider 852b within the nozzle body 852a.

The insert 844 receives and supports a first or inlet end of an air tube 854 which in this example is realized in the form of a hollow shaft. The air tube 854 includes one or more air jets 856 that are formed at appropriate angles and orientations as described herein before with respect to the other embodiments herein. In the example of FIG. 15, the air jets 856 produce a forward air flow towards the front of the gun 840, but are radially angled to direct powder against the inner surface 858 of the charging tube 850. The inlet end 854a of the air tube 854 is in fluid communication with the air inlet coupling 848. Therefore, pressurized air fed into the air inlet 848 via an air hose (not shown) enters the air tube 854 and exits through the various air jets 856. The air tube 854 generally coextends with the charging tube 850 and has a forward end 854b of the air tube 854 is closed and supported by the spider 852a.

As compared to the embodiments, for example, of FIGS. 2, 7, 3A-3D, 4A-4H, and 11, the concept of the inside-out gun is that the powder particles have a substantially shorter travel distance under the influence of the pressurized air from the air jets 856 before the particles impact the tribocharging surface of the charging tube 850. This reduces the amount of air to achieve adequate impact velocity to effect adequate charging of the powder and also reduces the amount of lost energy from the particles traveling down the gun. The air tube 854 may be also made of tribocharging material to further increase the tribocharging effect of the design. Another advantage of the inside-out design is that the gun is simpler to manufacture as it uses fewer parts.

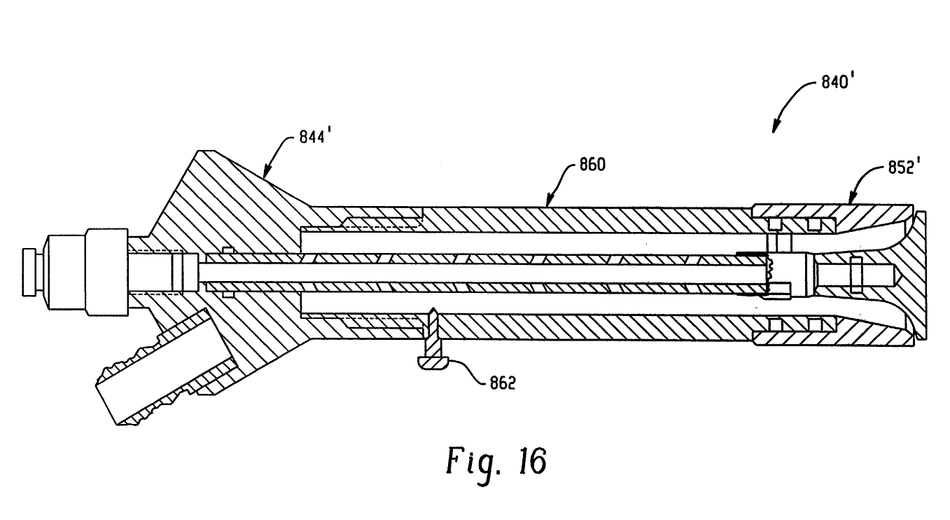

FIG. 16 shows a variation of the inside-out gun of FIG. 15. In FIG. 16, the gun 840′ has a central gun body 860 that also functions as the charging tube. The powder insert 844′ is attached at an inlet end of the body and a nozzle assembly 852′ is attached at an opposite end of the gun body 860. The nozzle assembly 852′ may be similar to that shown in FIG. 15 or may be of some other suitable design.

In both FIGS. 15 and 16, a grounding pin 862 extends through the gun body 842/860 to discharge the tribocharging surfaces and components inside the guns. The pin 862 is illustrated in FIG. 16 with the pin omitted in FIG. 15 to illustrate the pin bore 862a.

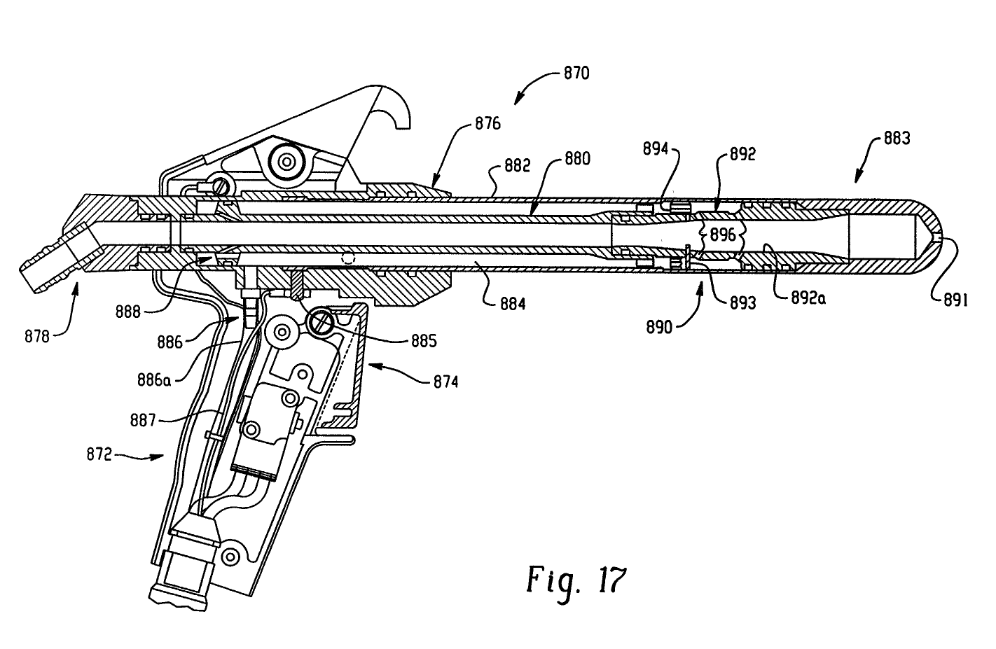

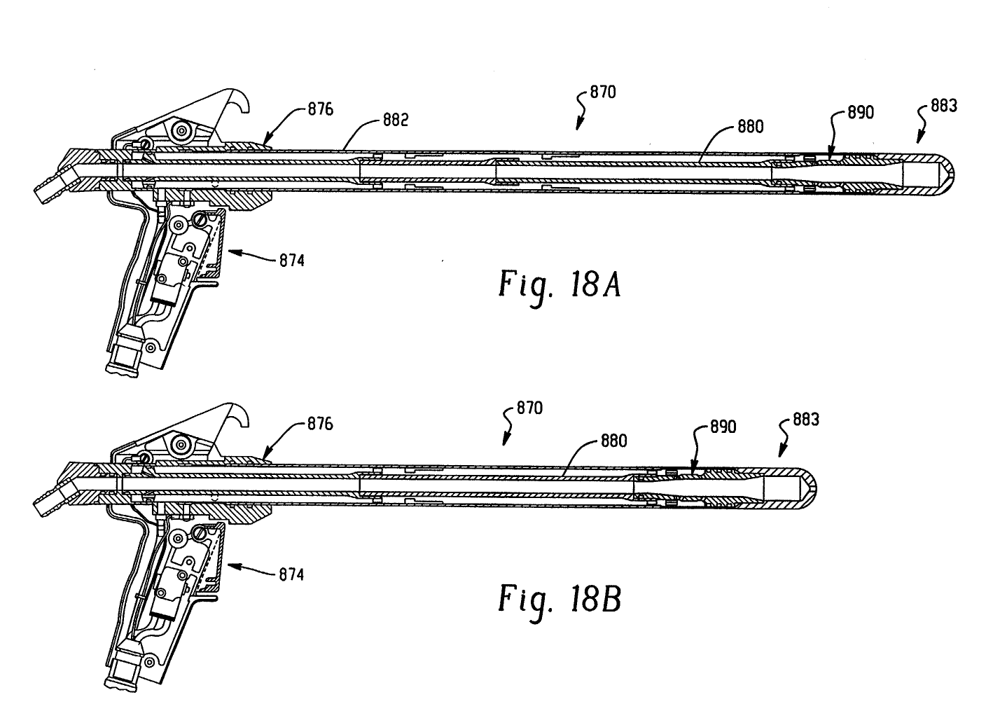

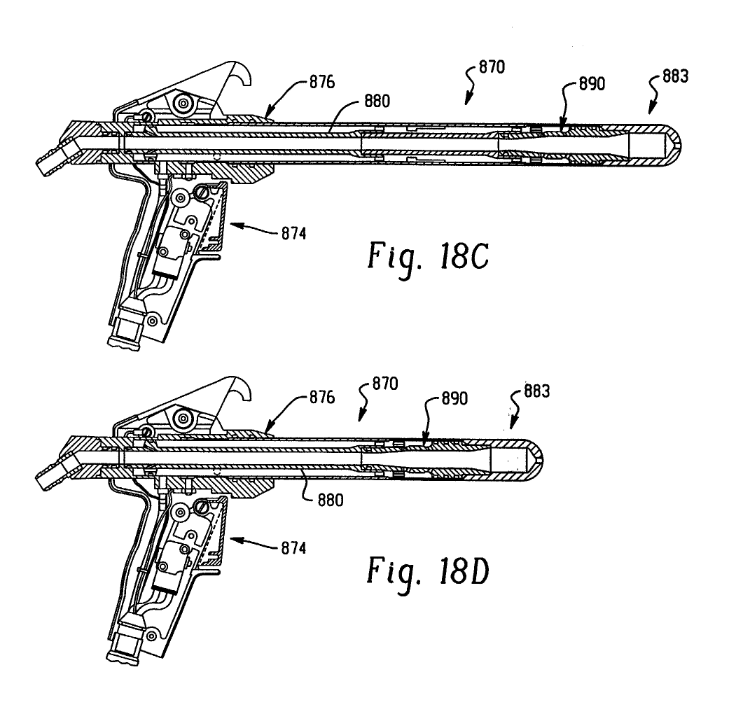

FIG. 17 illustrates an embodiment of the invention in a hand operated gun configuration. Previous embodiments herein are illustrated as automatic gun configurations such as are mounted on gun supports and gun movers, although the main elements of those embodiments may be incorporated into a manual gun handle, as exemplified in FIGS. 17 and 18.

In FIG. 17 then, the gun 870 includes a handle portion 872 having a trigger 874 or other control device for controlling the flow of powder through the gun 870. A gun body 876 supports a powder feed hose connector 878 to which a powder feed hose (not shown) may be connected. Powder flows down a powder extension tube 880 which may be made of tribocharging material. The extension tube 880 is supported within a gun body extension 882 that at an opposite end supports a nozzle assembly 883. The extension tube 880 is generally concentrically mounted within the gun body 876 and extension 882 to provide an annulus 884. This annulus 884 receives pressurized air through an air fitting 886 that is connected to an air line 886a extending up through the handle 872. A diffuser air passageway 888 is formed through the wall of the powder extension tube 880. The passageway 888 is sized so as to effect a desired balance between diffuser air entering the powder extension tube 880 and air that will travel down the annulus 884 to the charging portion 890 of the gun 870.

The charging portion 890 in this example is in the form of an outside-in gun, and includes a charging tube 892 that is inserted at one end into the forward end of the powder extension tube 880. The forward end of the charging tube 892 is assembled to the nozzle assembly 883. The charging tube 892 is supported by ribs or legs 894 that include or permit the air from the annulus 884 to pass through a series of air jets 896. The air entering the charging tube 892 directs the powder particles to impact the tribocharging surface 892a of the charging tube 892 as in the earlier described embodiments. It is contemplated that the extension tube 880 and the nozzle assembly 882 may also be made of suitable tribocharging materials to enhance the charging effect of the gun 870. The use of the internal diffuser air passageway 888 requires only a single air supply to the gun 870 for both diffuser air and air for the jets 896, thus eliminating any need for a second air port into the side of the gun at the portion 890. Although not shown in FIG. 17, a shaft similar in concept to the shaft 810 in FIG. 15 may be used in the gun configuration of FIG. 17.

The embodiment of FIG. 17 has a ground pin 893 which is connected to the extension 882 which is electrically conductive. The extension 882 is in turn connected to a grounding screw 885 which is electrically grounded by a ground wire 887. Placing the ground pin 893 at a location just behind, or upstream, of the location where tribocharging air assist jets 896 first impact the charging surface is preferred in that in this location the surface charge which builds up on the tribocharging surface due to the tribocharging of the powder can be readily discharged by ground pin 893 to promote tribocharging of the powder. If the ground pin is placed too far upstream from the point of air jet impingement, the surface charge which builds up on the surface will not be discharged by the ground pin. If the ground pin is placed in front of, or downstream of, the place where the tribocharging air jets impinge on the charging surface, the powder charged by impinging that surface will be discharged by the ground pin as the powder flows downstream over the ground pin.

In a typical tribocharging gun, extending the length of the gun barrel downstream of the tribocharging portion tends to cause a loss of charge before the powder is ejected through the nozzle. In FIGS. 18A-D we illustrate an alternative arrangement wherein for different gun lengths, the air jet induced tribocharging portion 890 is kept positioned closer to the nozzle, therefore the charge loss is minimized. In all of these embodiments, it is preferred that the ground pin or other ground element (not shown) be placed at a location just behind the place where tribocharging air assist jets first impact the charging surface as is done in the FIG. 17 embodiment.

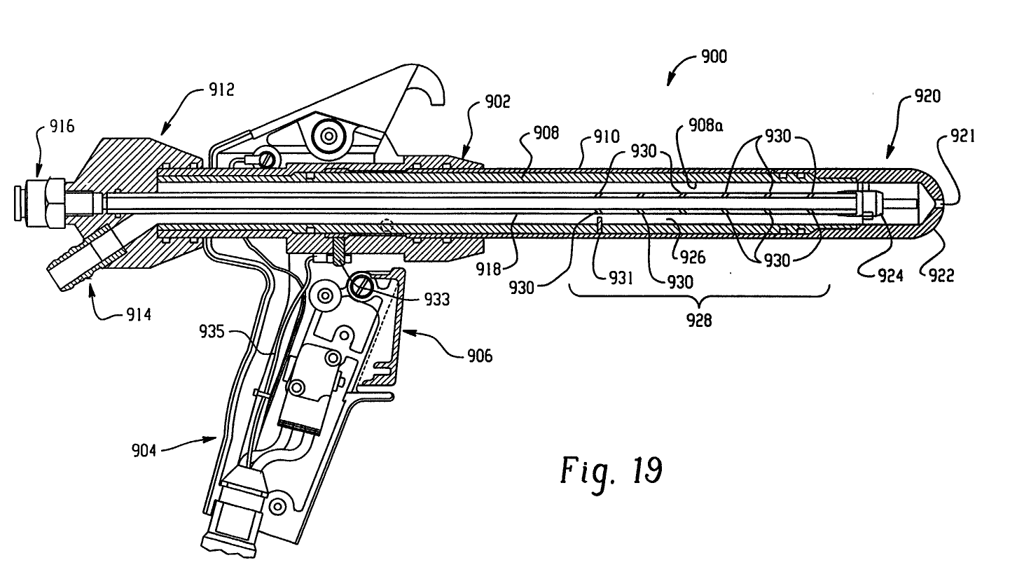

With reference next to FIG. 19, a spray gun is illustrated that incorporates the concept of an inside-out gun in a hand held manual spray gun configuration. The gun 900 includes a gun body 902 that has a handle 904. The handle 904 may include conventional trigger mechanisms 906 for controlling the flow of powder into the gun 900. The body 902 supports a charging tube 908 within a body extension 910. The charging tube 908 is made of a suitable tribocharging material as set forth hereinabove. At a rearward end of the gun body 902 is attached a powder inlet cap assembly 912, that in a manner similar to the embodiments of FIGS. 15 and 16, includes a powder hose connector 914 and an air fitting 916 (the air and powder supply lines being omitted from FIG. 19 for clarity). The air inlet 916 is in fluid communication with an air tube 918 that extends longitudinally through the gun 900 from the inlet head 912 to a nozzle assembly 920. In this embodiment, the nozzle assembly includes a flat spray nozzle 922 within which is installed a spider 924 that may be similar in design to the spider 852b of FIG. 15 herein. The spider 924 supports the forward end of the air tube 918. The air tube extends generally concentrically through the gun 900, thus providing an annulus 926 between the outer surface of the air tube 918 and the inner surface 908a of the charging tube 908. In a portion 928 of the gun 900 a number of air jets 930 are provided through the wall of the air tube 918 which are directed towards the forward end of the gun near the nozzle. The number, location, orientation and angles of the various air jets 930 may be selected for a particular gun design as explained hereinabove. The air jets 930 also need not be all at the forward end of the gun 900 but may also be located more towards the gun handle.

Powder enters the gun 900 through the coupling 914 and passes down the annulus 926. Appropriate sizing of the annulus 926 may be used to provide a tribocharging precharge to the powder before it reaches the portion 928 of the gun 900. Pressurized air flow from inside the air tube 918 out to the annulus 926, causing powder particles to impact the tribocharging surface of the charging tube 908. The air tube 918 may also be constructed of tribocharging material to increase the charging effect on the powder. Although the gun 900 is illustrated as having a charging tube 918 disposed within a gun extension 910, these two elements may if required be a single tube, as in the embodiment of FIG. 16 herein.

As in the previous embodiments, a ground pin 931 is placed at a location just behind the place where tribocharging air assist jets 930 first impact the charging surface. The grounding pin 931 is connected to the extension 910 which is electrically conductive. The extension 910 is grounded through a ground screw 933 to a ground wire 935.

Another advantage of the inside-out gun configurations illustrated herein is that if impact fusion should occur along portions of the charging tube surface, it is a straightforward operation to simply rotate the air tube 918 through an angle sufficient to reorient the air jets 930 towards “clean” tribocharging surface areas where there is no impact fusion. This exposes clean charging surface to the impacting powder particles and will improve the charging efficiency as the gun is used. Alternatively, the relative axial position between the air jets 930 and the tribocharging surfaces could be adjusted to expose clean charging surface to the powder, or both the relative axial and rotational positions could be changed.

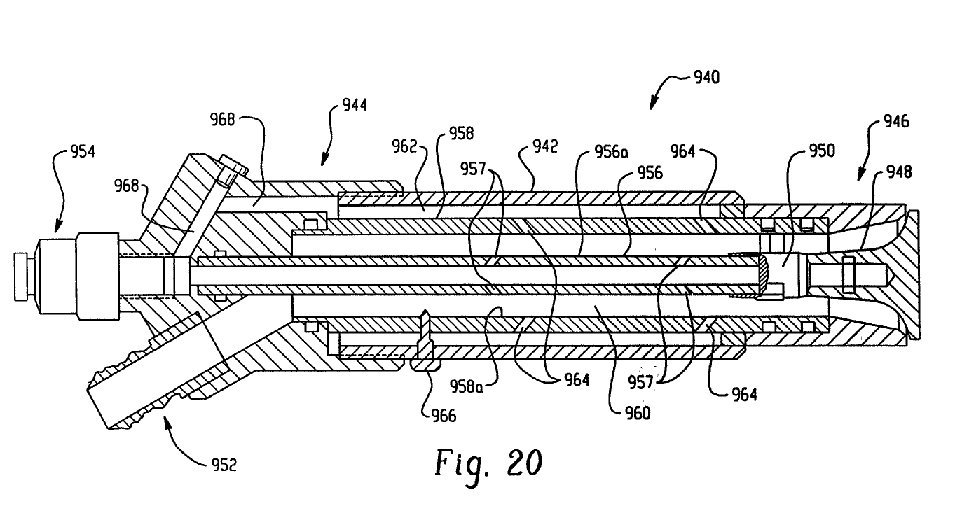

FIG. 20 illustrates another embodiment of the invention that combines the inside-out configuration with an outside-in configuration in a single gun. In this embodiment, the gun 940 includes a gun body 942 that supports at one end a powder inlet cap assembly 944 and at an opposite end a nozzle assembly 946. The nozzle assembly 946 is illustrated to be a conical nozzle type with a nozzle 948 supported by a spider 950 in a manner similar to other embodiments described herein.

The inlet assembly 944 includes a powder hose fitting 952 and an air fitting 954. The air fitting 954 is in fluid communication with an air tube 956 that extends through the gun to the nozzle assembly 946 and is supported at the forward end by the spider 950. A charging tube 958 is also supported inside the gun body 942 and concentrically surrounds the air tube 956 to form a second or outer annulus 960 therebetween. The air tube 956 includes a plurality of inside-out air jets 957 that allow air to pass from inside the air tube into the annulus 960. The charging tube 958 is sized with a diameter that is less than the diameter of the gun body 942, thereby providing an air passageway or second outer annulus 962. The charging tube 958 is also provided with a number of air jets 964 such that the charging tube 958 also functions as an outside-in air tube. Pressurized air flows from the second or outer annulus 962 through the charging tube air jets 964 into the first or inner annulus 960. Powder from the inlet 952 flows into the inner annulus 960 and is then entrained in the air flow produced by the air jets 957 and 964. The two sets of air jets, one outside-in and the other inside-out significantly increases the turbulence of the powder and causes impact with both the charging tube surface 958a and the air tube outer surface 956a. A grounding pin 966 is provided as previously described hereinabove.

Pressurized air enters the gun through the air fitting 954 and flows through the air tube 956. In addition, an air passageway 968 is provided that directs part of the air into the outer annulus 962. In this manner only a single air input is needed to the gun. If required, a portion or the air may also be directed into the inner annulus 960 to function as diffuser air, however this is unlikely to be needed as the volume of moving air from all the air jets will in most cases adequately diffuse the powder. The gun 940 may also include additional powder flow lengths prior to the charging operation to incorporate a tribocharge pre-charge or post-charge effect.

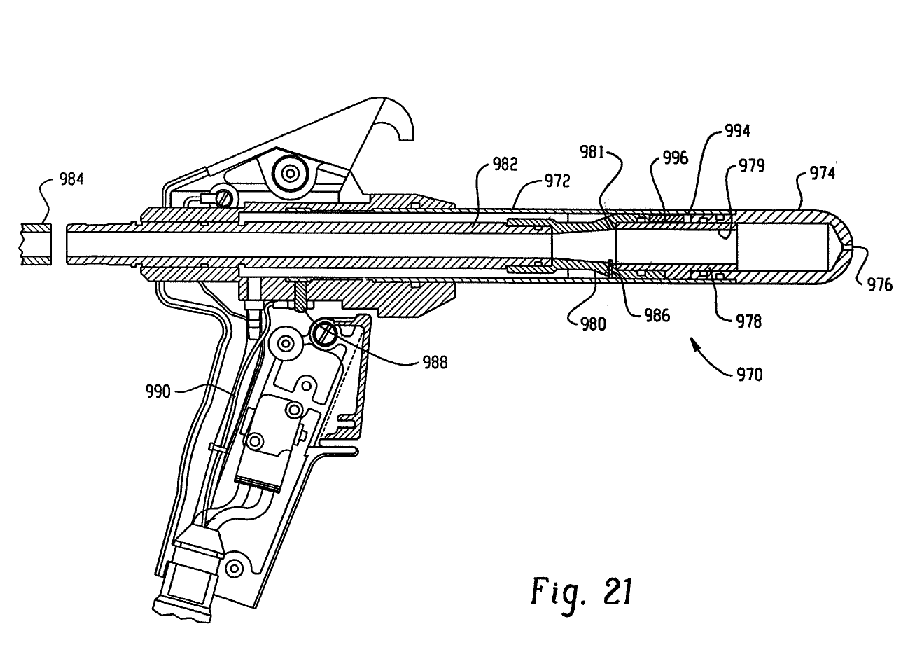

FIGS. 21-24 show another embodiment of the invention. In this embodiment, an electronically conductive extension 972 supports a nozzle 974 having a slot 976. A charge sleeve 978 is installed between the nozzle 974 and a charge sleeve holder 980. The powder feed tube 982 is inserted into the charge sleeve holder 980 and is connected to a powder feed hose 984. A ground pin 986 is connected to the extension 972. The extension 972 is connected through a ground screw 988 to a ground wire 990. The charge sleeve holder 980 includes air jets 981 which enhance the tribocharging ability of the gun. The jets 981 impinge upon the inside surface 979 of the charge sleeve 978 which is constructed from a tribocharging material such as those described above. The ground pin 986 is positioned just behind the place where tribocharging air assist jets 981 impact the charging surface 979.

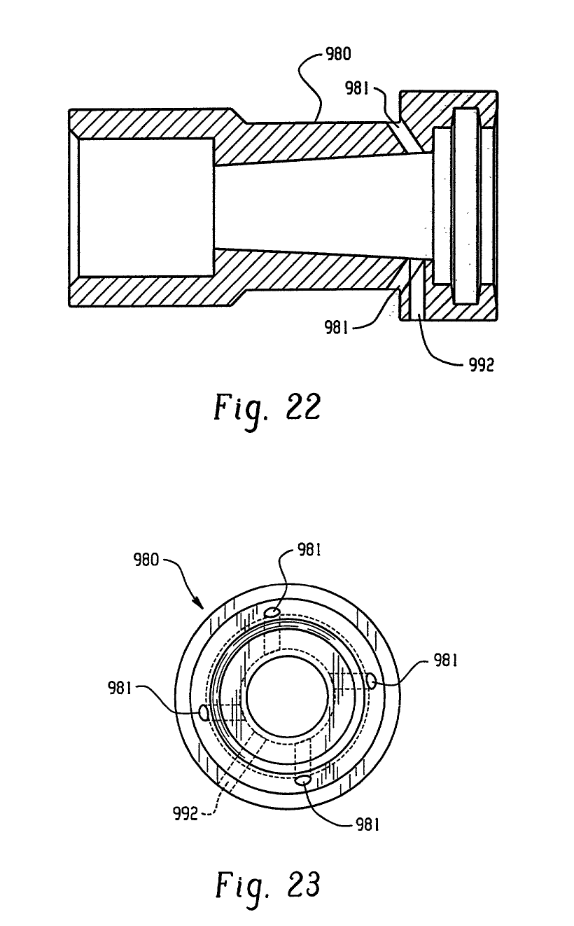

FIGS. 22 and 23 show the charge sleeve holder 980 in more detail. As shown in FIG. 23, the air jets 981 are disposed at 90 degree intervals around the circumference of the charge sleeve holder 980. The passage 992 for the ground pin 986 is shown in FIG. 23 as disposed between two of the air jets 981.

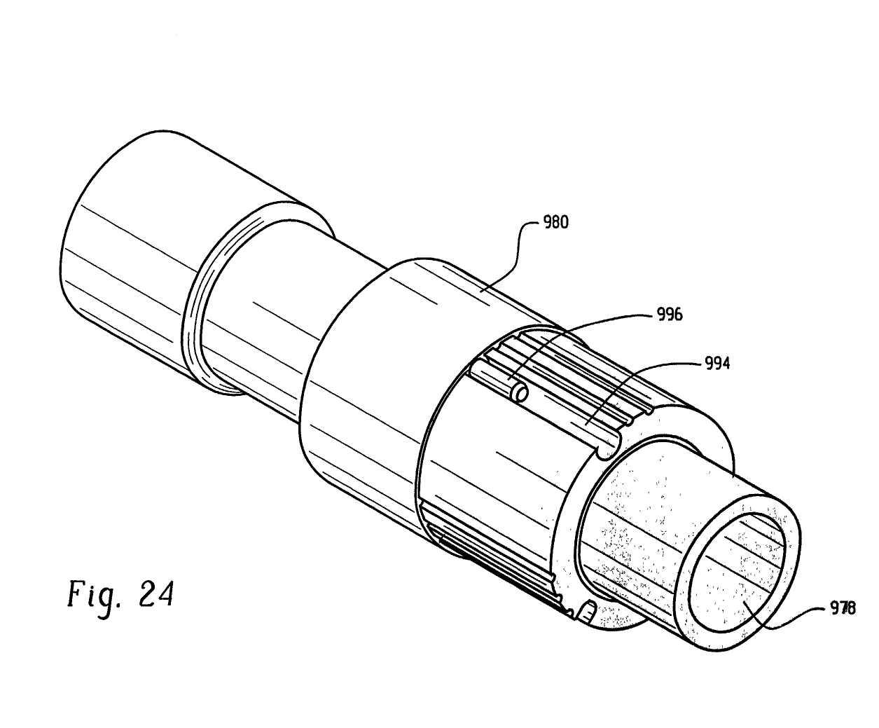

FIG. 24 shows a view of the charge sleeve 978 assembled to the charge sleeve holder 980. A locating pin 996 is frictionally received within the holder 980. When the charge sleeve 978 is assembled to the holder 980, the locating pin 996 is received within a slot 994 formed within the exterior surface of the sleeve 978. This permits the sleeve 978 to assume a particular positional orientation in the holder 980 (hereinafter referred to as a first orientation). In this first orientation, a certain portion of the interior surface 979 of the sleeve 978 is impacted by the air jets 981 and worn away by the frictional charging of the powder. In order to be able to expose different parts of the interior surface 979 to the air jets 981 a number of such slots are formed on the exterior of sleeve 978. To reorient the sleeve in holder 980 in a different positional orientation, the sleeve 978 would be pulled out of the holder 980 and rotated to align a different slot formed in the exterior of sleeve 978 with the pin 996 and the sleeve 978 would then be pushed back into holder 980. In this way a new portion of the charging surface 979 would be impacted by air jets 981 to be used for frictional, or triboelectric, charging of the powder without the need for replacing the charge sleeve 978. In addition, the sleeve 978 is symmetrical so that its orientation within the holder 90 can be reversed with the opposite and of sleeve 978 being inserted into holder 980. This doubles the number of different orientations the sleeve can assume within holder 980 to permit an even greater portion of the surface to be used for triboelectric charging before the sleeve 978 must be replaced.

Consequently, among the advantages of this embodiment is the employment of a novel concept in triboelectric gun of designing one or more components of the gun, which are used as a triboelectric charging surface, to be assembled into the gun in more than one orientation so that more of the surface can be used for tribocharging the powder before the component is replaced with a new component. This saves the customer money by enabling the customer to more fully utilize the component before replacing it.

A further cost savings is provided to the customer by forming the triboelectric charging assembly in two pieces as a charge sleeve and a charge sleeve holder. By constructing this component as a two piece assembly, only the charge sleeve holder, which includes the air jets and is more complicated to manufacture, does not have to be replaced. Thus the charge sleeve 978 is a much simpler part to manufacture and replace than a charge sleeve such as the one shown in FIG. 17 which includes the air jets as well as the charging surface.

Note also that in the FIGS. 21-24 embodiment all of the air jets 981 are in a single vertical plane. This produces a number of advantages. The charge sleeve can be shorter than charge sleeves with sets of air jets provided along the length of the charge sleeve. Also, any air introduced from the back of the gun will feed all the air jets uniformly, which produces more even charging of the powder. Further, all powder impact areas within the sleeve are close to the ground pin. In addition, a lower pressure can be used for air jets in a single plane, which reduces energy requirements, since there is no pressure drop between the first set of air jets and the second set of air jets.

In accordance with another aspect of the invention then, various combinations of air jet assisted tribocharging and tribocharging techniques can be implemented in a spray gun. These include but are not necessarily limited to: air jet assisted tribocharging followed by tribocharging; tribocharging followed by air jet assisted tribocharging; an inside-out air jet assisted tribocharging followed by tribocharging; tribocharging followed by an inside-out air jet assisted tribocharging; inside-out air jet assisted tribocharging followed by an outside-in air jet assisted tribocharging; and inside-out air jet assisted tribocharging combined with outside-in air jet assisted tribocharging. Various tribocharging material combinations may also be used in a gun, including positive and negative charging materials as required. A significant advantage of the air jet assisted tribocharging guns is that their short length design makes them suitable for coating the insides of pipes and other enclosed surfaces. The short gun length allows the gun to travel through a pipe that even has bends of various angles, which is difficult for prior art spray guns of significant length.

The present invention further contemplates apparatus and method for shaping and directing the flow of powder sprayed through a spray nozzle of an electrostatic spray gun. In general, the nozzle may be provided with openings that produce a desired shape or pattern to the powder spray. The powder spray pattern may also be shaped and directed by deflector devices that are mounted on the nozzle to shape and/or influence the powder spray pattern. These nozzle features may be used individually or in any suitable combination, and may be incorporated into any powder spray nozzle including but not limited to nozzles for corona spray guns and triboguns with the latter including without limitation conventional tribocharging spray guns or unconventional tribocharging spray guns as described herein.

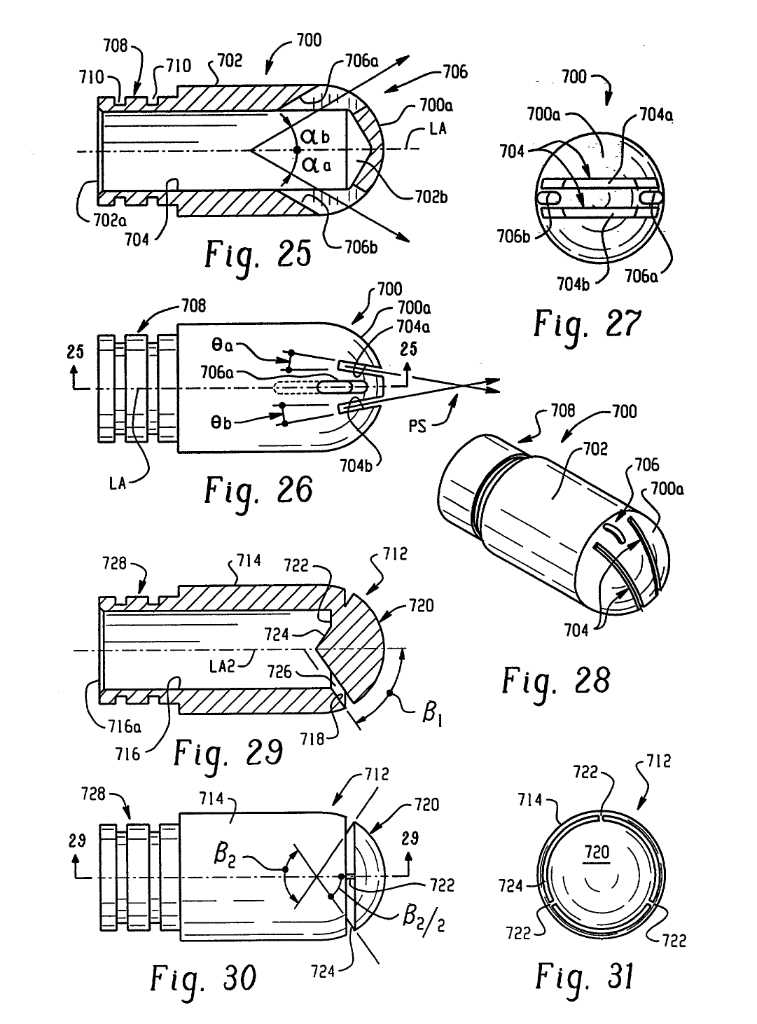

With reference to FIGS. 25-28, a first embodiment of a spray nozzle 700 in accordance with the invention is illustrated. The nozzle 700 includes a generally cylindrical body 702 having a central axial passageway in the form, for example, of a bore 705 therein that extends from a powder inlet end 702a to an outlet end 702b. A first plurality of openings or slots 704 are provided at a rounded front end 700a of the nozzle 700. This first set of slots 704 are used to form a primary powder spray pattern indicated by the directional arrows PS on FIG. 26. The front end 700a need not be rounded but may have other suitable shapes to produce a desired pattern. The slots 704 therefore need not be arcuate as illustrated in the exemplary embodiment.

Each slot 704a and 704b is angled with respect to the longitudinal axis LA of the nozzle 700. In this exemplary embodiment, the nozzle 700 includes two arcuate slots 704a and 704b respectively aligned at angles ⊖ₐ and ⊖_{b} with respect to the longitudinal axis LA. Preferably but not necessarily the angles ⊖ₐ and ⊖_{b} are substantially equal. The values of ⊖ₐ and ⊖_{b} are selected based on the desired characteristics of the spray pattern. In one example, ⊖ₐ and ⊖_{b} are about 15 degrees to form an included angle between the slot 704a and 704b of about 30°. Other angles may be selected as required but it is contemplated that the angles ⊖ₐ and ⊖_{b} will be other than zero degrees (i.e., parallel to the axis LA). By having the slots angled relative to the axis LA, powder flowing through the slots 704 is directed to converge and impinge each other as indicated by the intersection of the arrows PS. This convergence causes a decrease in the velocity of the powder spray and produces a wider powder spray pattern with better more uniform dispersion or distribution of the powder particles within the spray pattern as compared to single slot nozzles or parallel slot nozzles.

The angled slots 704 have additional benefits. Because of the angled orientation, it is less likely that powder particles could pass straight through the nozzle 700 and out one of the slots 704 without impacting an interior surface area of the nozzle body 702. By increasing impact or surface contact of the powder against the nozzle 700, the tribocharging effect can be enhanced. Thus it is preferred although not necessary that the nozzle 700 or at least the impact surfaces within the nozzle 700 be made of a suitable tribocharging material of the same polarity as the spray gun to which the nozzle 700 is attached. For example, if the nozzle 700 is used with a corona gun or an unconventional negative tribogun as described herein, the nozzle may be made of Delrin™ or other suitable negative polarity tribocharging materials. If the nozzle is being used with a positive tribogun, the nozzle may be made of any suitable positive tribocharging materials such as PTFE for example. The angled slots 704 also increase the impact surface area of powder before the powder is ejected from the nozzle.

The angles ⊖ₐ and ⊖_{b} typically will be within a useful range. If the angle ⊖ is too shallow, backpressure will be reduced and powder could flow through the nozzle 700 unimpeded. If the angle ⊖ is too steep there may develop too much backpressure and too low a powder flow rate through the slots 704.

The angled slots 704 also cause backpressure to build within the nozzle body 702, thus slowing down the velocity of the powder spray and increasing collisions of the powder particles with each other and impact with the nozzle interior tribocharging surfaces, thereby enhancing the tribocharging effect of the nozzle. The number of slots used is a matter of choice.

The slots 704 are shaped so as to produce a somewhat flat fan-like spray pattern. Because powder particles vary in size and mass, the spray pattern produced by the slots 704 alone may not exhibit a desired powder distribution within the spray pattern. In many cases, use of the angled slots 704 alone will be sufficient. However, if so required or desired, the nozzle 700 is provided with a second set of openings or vents 706. In this example there are two vents 706a and 706b but alternatively a single vent may be used or more than two may be used.

As best illustrated in FIG. 27, the vents 706 are preferably although not necessarily positioned between the slots 704 near the end portions thereof. Other locations may be used. The vents are also each angled outwardly relative to the longitudinal axis LA at respective angles αₐ and α_{b}. In one embodiment the anglesαₐ and α_{b} are equal but they need not be. A suitable angle is about 30° to form an included angle between the vents of about 60°, however other angles may be used to achieve a desired effect on the spray pattern.

The vents 706 may be used for a number of different purposes. The vents provide pressure relief to reduce or control the backpressure within the nozzle 700 by venting air. Also, some powder will also be vented and will tend to flow about the peripheral region or envelope of the spray pattern thus increasing the amount of powder particles in that region (which typically includes a significant amount of fines). The outward envelope of air flow and powder also helps slow down the resultant powder spray and help to direct the powder spray in a forwardly direction (recognizing that the convergent powder streams from the nozzle slots 704 will cause some powder to deflect at angles away from a generally forward direction; the flow from the vents 706 assists in constraining such powder into the generally forward moving spray pattern.) Note that depending on the desired spray pattern the slots 704 and vents 706 may individually be either converging or diverging and may have various shapes and orientations.

The nozzle body 702 may include a suitable extension 708 with seal grooves 710 so that the nozzle can be press fit or otherwise installed at a forward end of a spray gun.

In some spraying applications, a generally circular spray pattern is desired. Such spray patterns are commonly produced by the use of a diffuser such as the conical nozzle 836 illustrated in FIG. 13 herein. However, such arrangements require multiple parts such as the nozzle 836, spider 830 and holder 826.

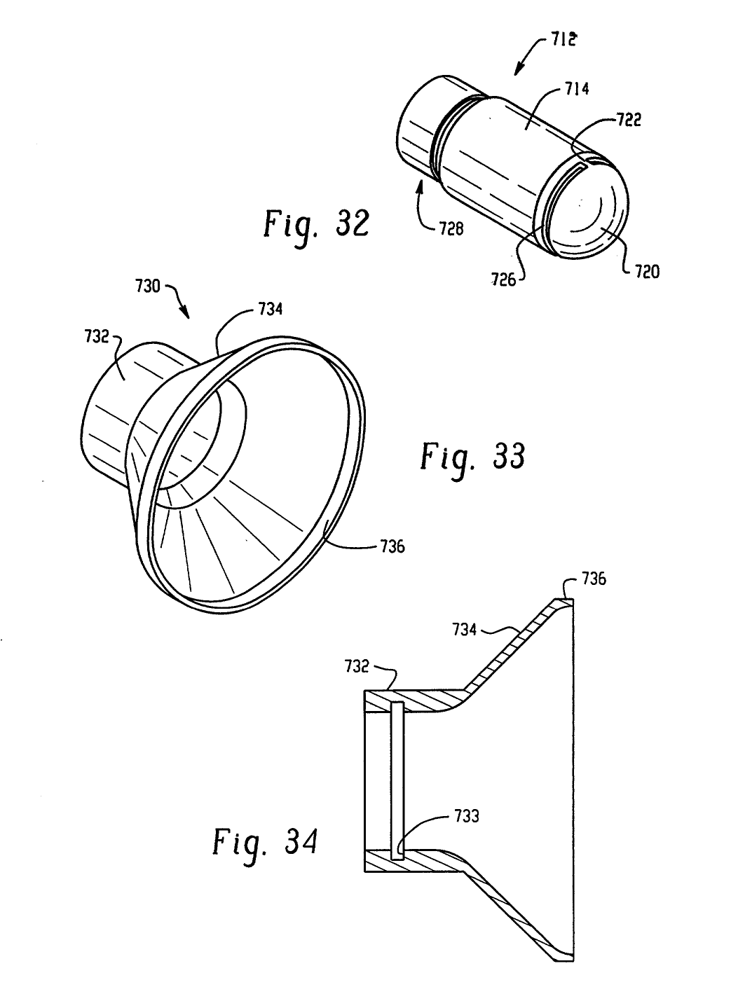

With reference to FIGS. 29-32 a second embodiment of a spray nozzle 712 in accordance with the invention is illustrated. This nozzle 712 may be used with any powder spray gun including but not limited to corona and triboguns. Preferably although not necessarily the nozzle 712 is made of a tribocharging material that electrostatically charges powder with the same polarity as the spray gun, similar to the nozzle 700 described herein.

The nozzle 712 includes a body 714 having a central longitudinal bore 716 therein. The bore 716 extends from an inlet end 716a to an outlet end 716b. The outlet end 716b includes an interior surface 718 that tapers radially outward at an angle β₁, relative to the longitudinal axis LA2 of the nozzle 712.

A deflector in the form of a cone 720 is disposed at the outlet end 716b of the nozzle 712. This cone 720 is used to produce a conical deflection of the powder flow exiting the nozzle bore 716 to cause the powder spray pattern to be generally circular (the spray cloud itself being generally conical). The cone 720 is preferably although not necessarily centered with respect to the outlet end 716b of the nozzle. The cone angle β₂ may be selected to be any angle that produces the desired size spray pattern. For example, 55° is a suitable angle in many applications. The cone angle β₂ may be selected such that the value β₂/2 is about equal to β₁. However this need not be the case in all applications.

In the exemplary embodiment, the cone 720 is attached to the nozzle 712 by a number of ribs 722. Although three ribs are illustrated, other numbers may be used. The ribs 722 are equidistantly spaced about the cone circumference (120° increments for 3 ribs) to stabilize the cone 720 during spraying. The ribs 722 connect an outer surface 724 of the cone 720 to the tapered nozzle surface 718 although other locations and attachment techniques may be used. Preferably but not necessarily the cone 720, ribs 722 and nozzle body 714 are integrally formed either by machining or molding. Alternatively, the cone 720 may be a separate part suitably attached to the nozzle body 714. The cone 720 or at least the cone surface 724 may be made of a suitable tribocharging material.

The cone 720 and the tapered nozzle end 718 thus are appropriately spaced apart to form a conical nozzle orifice or path 726. The dimensions and angles of the orifice 726 may be selected to effect a desired spray pattern size. If so desired, vents (not shown) may be used with the conical nozzle 712 as described herein with the embodiment of FIGS. 25-28. The nozzle 712 may also be provided with a mounting extension 728 similar to the extension 708 previously described herein (FIG. 25).

For the generally circular spray nozzle 712 embodiment, although a wider more uniform spray pattern is produced, in some applications it may be desired to constrain the powder spray pattern and also to assist in the forward movement of the spray pattern. In accordance within this aspect of the invention, a device may be attached to the nozzle and function as a deflector or shroud to shape and direct the powder spray pattern. The device may also function as a velocity brake to further assist in reducing the forward velocity of the spray pattern.

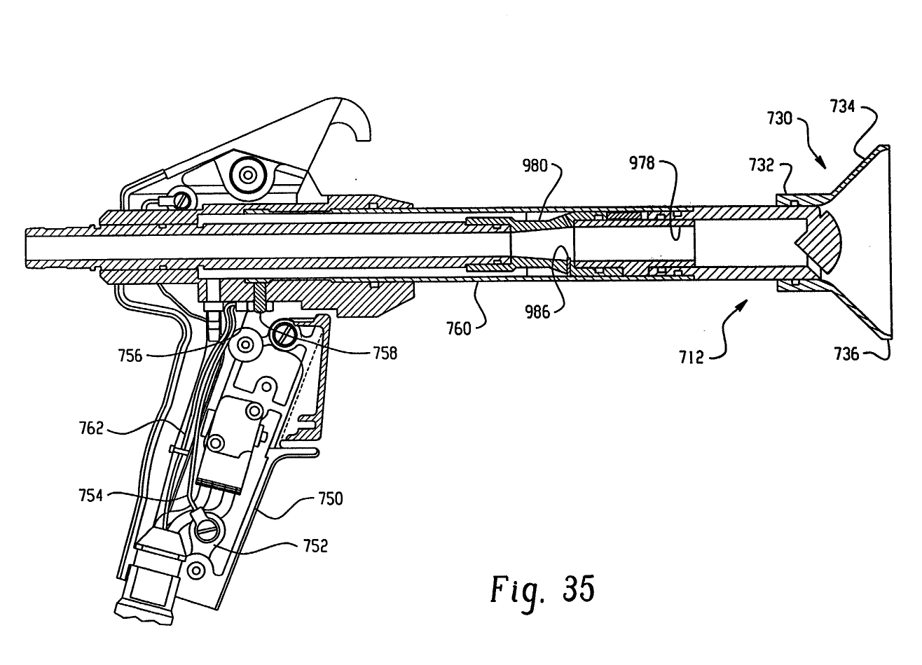

In a first embodiment of FIGS. 33 and 34, such a device is realized in the form of a deflector or shroud 730. The deflector 730 includes a sleeve portion 732 adapted to slip fit over the outside of a spray nozzle (FIG. 35). The sleeve 732 may include a seal groove 733 that retains an o-ring (not shown) or other suitable part that provides a seal and helps keep the deflector 730 on the nozzle. It should be noted that the deflector 730 may be used with other powder spray nozzles including but not limited to the generally flat spray pattern nozzle 700 herein.

As best illustrated in FIGS. 34 and 35, the deflector 730 includes a shroud-like cone portion 734 that envelops the forward end of the spray nozzle 712. The cone 734 flares at an appropriate angle to produce the desired spray pattern size and shape. The cone 734 includes a lip 736 at its forward end. This lip 736 may be used to assist in constraining the size of the spray pattern and also to direct the spray pattern forwardly. The deflector 730 is particularly but not singularly suited for larger spray patterns. The conical shape and the lip 736 also function to brake the velocity of the powder spray from the nozzle 712. A conical shape is not required however and any suitable shape may be selected to produce a desired spray pattern. The deflector 730 can even be selectively “decoupled” by sliding it backward to a position where it no longer envelops or influences the spray pattern, without requiring complete disassembly thereof.

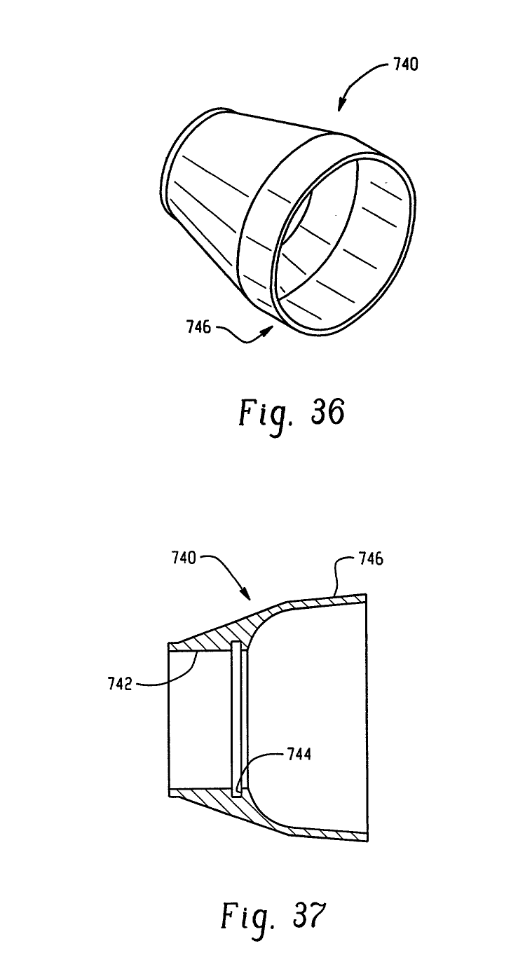

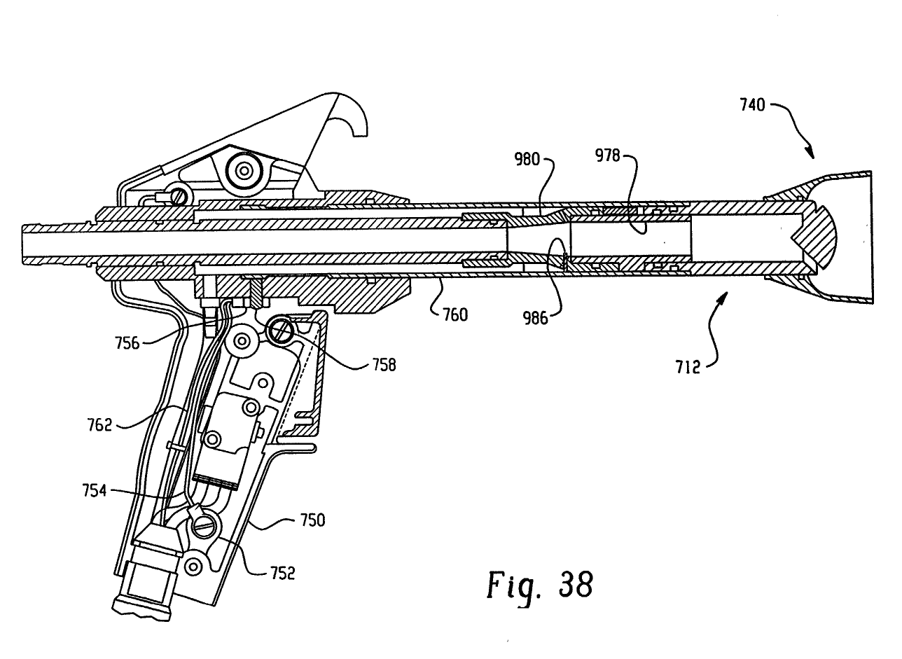

FIGS. 36-38 illustrate another embodiment of a device used to shape a powder spray pattern. In this embodiment, a deflector 740 includes a central base 742 that allows the deflector 740 to be slip fit onto a nozzle (FIG. 38). The base may include a groove 744 that retains a seal such as an o-ring in a manner similar to the above-described embodiment of FIGS. 33-35.

In this example, the deflector 740 includes a flared cone or shroud portion 746 that outwardly flares along its entire length. By omitting an end lip, the deflector 740 allows for a spray pattern having a higher velocity with smaller spray pattern sizes, particularly useful for spraying into corners and small parts. Again, adjusting the axial position of the deflector on the nozzle allows an operator to change the spray pattern size and the influence of the deflector on the spray pattern.

Note that the deflectors 730, 740 may be made of an appropriate tribocharging material to enhance electrostatic charging of the powder spray, as described herein above.

With reference to FIGS. 35 and 38, in some applications it may be desired to have the operator grounded at the same potential as the feedback ground of the tribogun. To accommodate this, the handle 872 may include an electrically conductive shell 750. This shell 750 is electrically in contact with a grounding lug 752 inside the handle 872. A ground wire 754 is attached at one end to the grounding lug 752 and at its other end to a second grounding lug 756. The second ground lug 756 is electrically connected to a ground pin 758 which in turn is electrically connected to the conductive extension 760 of the gun, which is used to bleed off charge via the ground pin 986 from the tribocharging surfaces as described hereinbefore. A second ground wire 762 is routed from the ground lug 756 to earth ground through the handle 872.

With reference again to FIGS. 18A-D and 21, the gun length may be changed by changing the length of the tubular gun extension 870/972. The gun extension 870/972 is a conductive member such as made out of a suitable metal, for example, aluminum. The extension 870/972 is conductive so as to provide a feedback ground path to bleed off charge buildup on the tribocharging surfaces, such as are readily produced on the impact surfaces of the charging portion 890/970. These charges or ions may be grounded to the extension 972 via the ground pin 986 (FIG. 21).

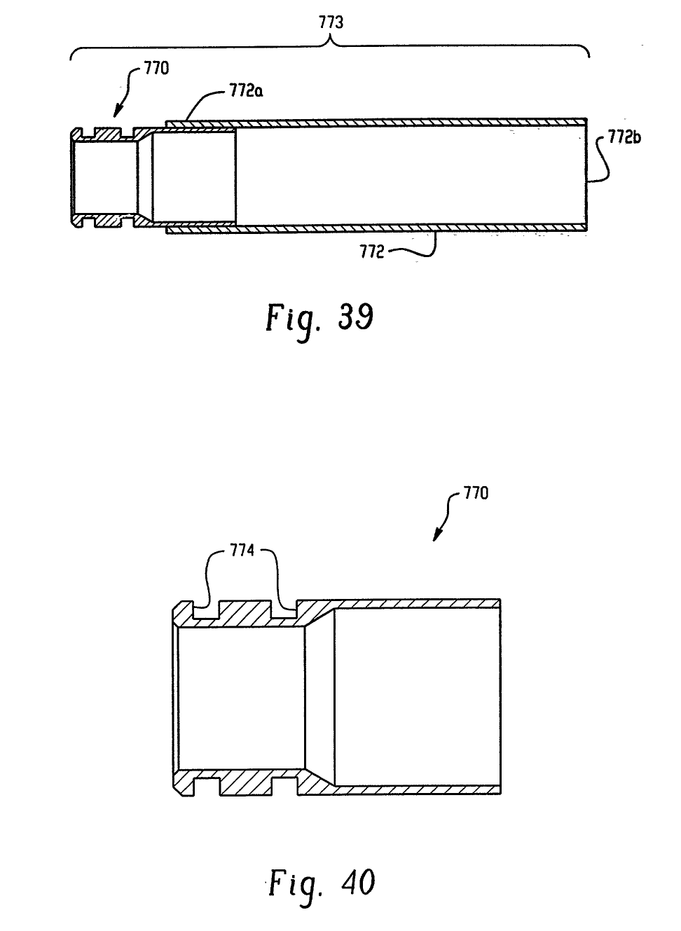

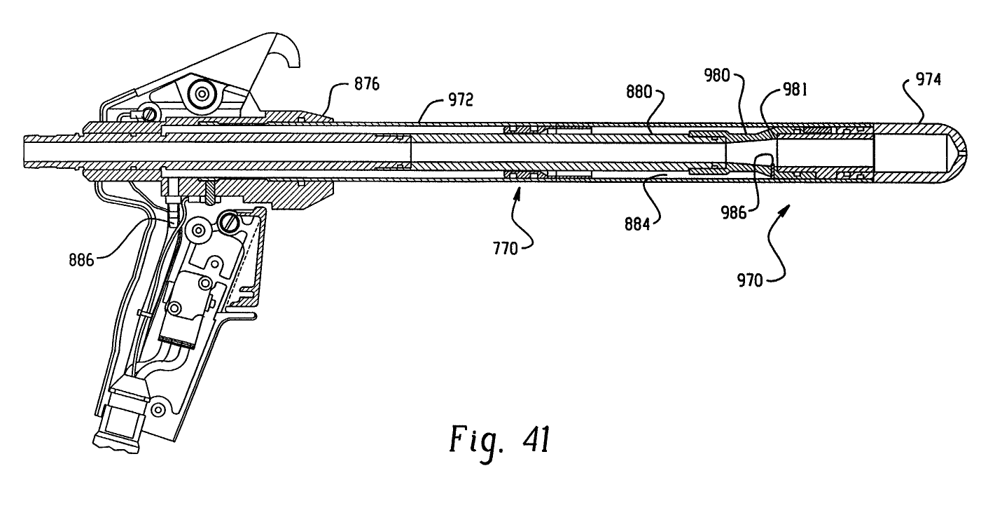

In order to facilitate rapid gun extension length changes, as illustrated in FIGS. 39-42, the extension has been modified to include a splice or coupling 770. The splice 770 is press fit inserted into a rearward end 722a of a barrel extension 772 to form an extension assembly 773. The splice 770 may include one or more seal grooves 774 to retain respective o-rings or similar seals. The seals (not shown) provide a seal function and also help to secure the assembly 770, 772 in the gun body 876. The free end of the splice 770 is slip fit inserted into the forward end 972a of the gun extension 972 (FIG. 41) such that the forward end of the extension 972 abuts the back end 772a of the added barrel extension assembly 773.. A forward end 772b of the barrel extension assembly 773 slideably receives the charge sleeve portion 890 with a nozzle 974 mounted thereto such that the front end 772b of the barrel extension assembly 773 abuts a shoulder 775 of the nozzle 974. Note that the grounding pin 986 makes contact with the newly added barrel extension 772 to insure discharge of the tribocharging surfaces in the charge sleeve 980.

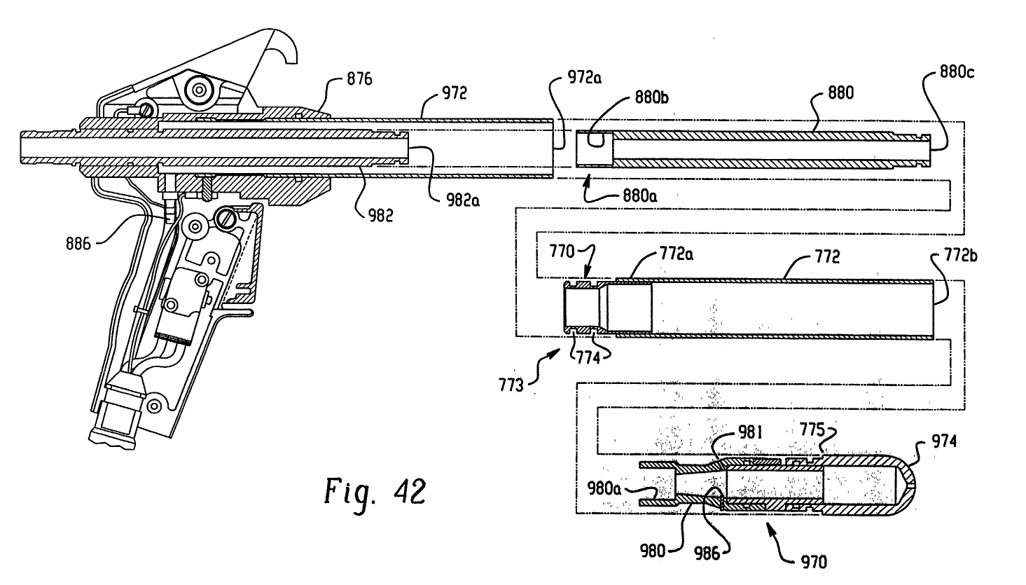

The overall gun length therefore has been increased (or decreased by opposite steps) by simple slip fit connections while maintaining overall smooth outer contour of the gun. Thus, the gun length can be quickly and easily changed with two simple slip fit disconnects (FIGS. 41 and 42) and reconnects of the extension 772 at the ends thereof (to effect size changes exemplified in FIGS. 18A-D). An operator can therefore quickly change gun length with minimal downtime during a spraying operation. The barrel extension concept and “length change on the fly” may be implemented with any suitable nozzle design or gun body design.

The gun body 876 and gun extension assembly 773 form an outer wall of the air annulus or manifold 884 that receives air from the air fitting 886. This air manifold 884 is used to provide pressurized air to the air jets 981.

Gun length adjustment on the fly is facilitated by the simple press fit assembly of the two ends 773a, 773b of the gun extension assembly 773 (FIG. 42). Because the charging portion 970 remains at the forward end of the spray gun, the extension 772 may be made any length without adversely affecting the tribocharging capability of the gun or the feedback grounding feature. Note that the length of the powder inlet tube 982/880 must also be changed commensurate with any change in the length of the extension assembly 773. This can be accomplished by simply adding or removing slip-fit interconnected powder tube extension pieces 880 as illustrated in FIGS. 18A-D. The back end 880a of the extension 880 includes a socket 880b that slideably receives the nose portion 982a of the powder inlet tube 982. A front or nose portion 880c slip fits into a socket 980a at the back end of the sleeve holder 980, or alternatively a socket at the back end of another powder tube extension (not shown in FIG. 42). Each slip fit connection may include appropriate seals as required.

The designs illustrated in FIGS. 18A-D, 21 and 41, 42 include the feature of positioning or aligning the air jets 981 with reference to a single vertical plane (relative to the spray gun longitudinal axis) and proximate the discharge pin 986. This maintains a more uniform air distribution to the air jets and positions the pin 986 (near impact areas) at a location to best bleed off residual charge produced by the tribocharging process in the primary charging portion 970 of the gun.

The various aspects of the invention described herein including but not limited to the gun extension (length change), angled and conical nozzle slots and vents, and deflectors may be used individually or any combination thereof as required for a particular spraying procedure.

While the invention has been described with reference to a preferred embodiment, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that invention not be limited to the particular embodiment disclosed as the best mode contemplated for carrying out this invention, but that the invention will include all embodiments falling within the scope of the appended claims.

Having thus described the invention, we claim:

1. An apparatus for spraying powder coating material having a powder flow path, wherein said powder flow path has a charging surface for triboelectrically charging powder coating material which comes in contact with said charging surface, said charging surface comprising a negative tribocharging material selected from polyamide resin blends, fiber reinforced polyamides, aminoplastic resins and acetal polymers.

2. The spray apparatus of claim 1 further comprising one or more air passages formed through said charging surface, said air passages being in a fluid communication with a source of compressed air.

3. The spray apparatus of claim 1 further comprising an electrical conductor provided adjacent said charging surface, said electrical conductor being connected to one of an electrical ground or a source of electrical potential.

4. The spray apparatus of claim 3 further comprising one or more air passages formed through said charging surface, said air passages being in a fluid communication with a source of compressed air.

5. An apparatus for spraying powder coating material having a powder flow path, wherein said powder flow path having a charging surface for triboelectrically charging powder coating material which comes in contact with said charging surface, further comprising one or more air passages formed through said charging surface, said air passages being in a fluid communication with a source of compressed air.

6. The spray apparatus of claim 5 wherein said charging surface comprises a negative tribocharging material selected from polyamide resin blends, fiber reinforced polyamides, aminoplastic resins and acetal polymers.

7. The spray apparatus of claim 5 further comprising an electrical conductor provided adjacent said charging surface, said electrical conductor being connected to one of an electrical ground or a source of electrical potential.

8. An apparatus for spraying powder coating material having a powder flow path through which said powder coating material flows, wherein said powder flow path has a first charging surface for triboelectrically charging powder coating material which comes in contact with said first charging surface, said first charging surface comprising a tribocharging material having a first charging polarity, said apparatus further comprising a component through which said powder coating material also flows, said component having a second charging surface which also comprises a tribocharging material having said first charging polarity.

9. The apparatus of claim 8 wherein said component is a spray nozzle.

10. The apparatus of claim 9 wherein said spray nozzle includes air passages which are in fluid communication with a source of compressed air.

11. The apparatus of claim 8 wherein said first charging polarity is a negative charging polarity.

12. The apparatus of claim 11 wherein said first charging surface comprises a negative tribocharging material selected from polyamide resin blends, fiber reinforced polyamides, aminoplastic resins and acetal polymers.

13. A system for applying powder coating materials to articles, said system including a powder feed apparatus for supplying powder coating material and an apparatus for spraying powder coating material received from said feed apparatus, said spraying apparatus having an electrode for charging said powder coating material a first charging polarity, said feed apparatus including a component having a charging surface for triboelectrically charging powder coating material which comes in contact with said charging surface, said charging surface being comprised of a tribocharging material having said first charging polarity.

14. The system of claim 13 wherein said component comprises at least one of a fluidizing plate, a hopper wall, a suction tube for a pump, a component of a pump or a hose.

15. The system of claim 13 wherein said charging surface comprises a negative tribocharging material selected from polyamide resin blends, fiber reinforced polyamides, aminoplastic resins and acetal polyamides.

16. The system of claim 13 wherein said spray apparatus includes a charging surface for charging said powder coating material said first charging polarity.

17. The system of claim 16 wherein said charging surface comprises a negative tribocharging material selected from polyamide resin blends, fiber reinforced polyamides, aminoplastic resins and acetal polymers.

18. A system for applying powder coating materials to articles, said system including at least one corona charging spraying apparatus and at least one tribocharging spraying apparatus, said corona charging spraying apparatus having an electrode for charging said powder coating material a first charging polarity, said tribocharging spraying apparatus having a powder flow path, wherein said powder flow path has a charging surface for triboelectrically charging powder coating material which comes in contact with said charging surface, said powder coating material being charged to said first polarity by said charging surface of said tribocharging spraying apparatus.

19. The system of claim 18, wherein said first charging polarity is a negative electrical polarity.

20. The system of claim 19, wherein said charging surface comprises a negative tribocharging material selected from polyamide resin blends, fiber reinforced polyamides, aminoplastic resins and acetal polymers.

21. The system of claim 20, said system further including a powder feed apparatus for supplying powder coating material to at least one of said corona charging spraying apparatus and said tribocharging spraying apparatus, said feed apparatus including a component having a charging surface for triboelectrically charging powder coating material which comes in contact with said charging surface, said component charging surface being comprised of a tribocharging material having said first polarity.

22. The system of claim 21 wherein said component charging surface comprises a negative tribocharging material selected from polyamide resin blends, fiber reinforced polyamides, aminoplastic resins and acetal polymers.

23. The system of claim 21 wherein said powder feed apparatus supplies powder coating material to at least one corona charging spraying apparatus and at least one tribocharging spraying apparatus.

24. The system of claim 18 wherein said corona charging spraying apparatus is used to coat a first part of said article and said tribocharging spraying apparatus is used to coat a second part of said article.

25. The system of claim 24 wherein said the second part of said article is a recessed part of said article.

26. The system of claim 24 wherein said corona charging spraying apparatus first applies powder coating material to said first part of said article and then said tribocharging spraying apparatus applies powder coating material to said second part of said article.

27. A tribocharging powder spraying apparatus, said apparatus including a body having an internal bore, a wear tube being located within said internal bore, an open passageway being provided between said internal bore and said wear tube, at least one air jet passageway being provided through said wear tube, said air jet passageway providing fluid communication between said open passageway and the interior of said wear tube, said wear tube having a charging surface for triboelectrically charging powder coating material which comes in contact with said charging surface, said open passageway being in a fluid communication with a source of compressed air, whereby compressed air flows from said open passageway through said air jet passageway into the interior of said wear tube to affect the flow of powder coating material through said wear tube.

28. The tribocharging powder spraying apparatus of claim 27 further comprising an inner wear surface located within said wear tube, said inner wear surface having a charging surface for triboelectrically charging powder coating material which comes in contract with said charging surface.

29. The tribocharging powder spraying apparatus of claim 27 wherein said charging surface comprises a negative tribocharging material selected from polyamide resin blends, fiber reinforced polyamides, aminoplastic resins and acetal polymers.

30. A system for applying powder coating materials to articles, said system including a powder feed apparatus for supplying powder coating material and an apparatus for spraying powder coating material received from said feed apparatus, said feed apparatus including a component having a charging surface for triboelectrically charging powder coating material which comes in contact with said charging surface, said component charging surface being comprised of a negative tribocharging material selected from polyamide resin blends, reinforced polyamides, aminoplastic resins and acetal polymers.

31. An apparatus for spraying powder coating material having a powder flow path, said powder flow path having a charging surface for triboelectrically charging powder coating material which comes in contact with said charging surface, further comprising one or more air passages formed through said charging surface, said air passages being in a fluid communication with a source of compressed air; and a tribocharging insert disposed within said powder flow path to shorten powder travel distances to impact said charging surface.

32. The apparatus of claim 31 wherein said powder flow path is generally cylindrical and said insert is generally cylindrical and has a smaller diameter than said powder flow path.

33. The apparatus of claim 32 wherein said insert and powder flow path form an annulus, wherein powder passing through said annulus is tribocharged.

34. The apparatus of claim 33 wherein said air passages are upstream of said annulus.

35. The apparatus of claim 33 wherein said air passages open to said annulus.

36. An apparatus for spraying powder coating material having a powder flow path, said powder flow path having a charging surface for triboelectrically charging powder coating material which comes in contact with said charging surface, further comprising an air flow path coextending within said charging surface and spaced therefrom; said air flow path being defined by a wall having one or more air passages formed through said wall, said air passages being in a fluid communication with a source of compressed air.

37. The apparatus of claim 36 wherein said air flow path is defined by a tubular wall concentrically disposed within a larger tube that forms said charging surface.

38. The apparatus of claim 36 comprising a body that forms part of a spray gun; wherein said charging surface is formed in part by said gun body.

39. The apparatus of claim 36 wherein said air flow path wall comprises an outer surface that triboelectrically charges powder coating material that impacts said outer surface.

40. The apparatus of claim 36 comprising outer air passages formed through said charging surface.

41. A triboelectric powder coating gun having a component which includes a triboelectric charging surface, said component being capable of assembly into said gun in at least two different positional orientations.

42. The gun of claim 41 wherein said component when assembled into said gun has been rotated from a first position to a second position.

43. The gun of claim 41 wherein the direction of said component when assembled into said gun has been reversed from a first position to a second position.

44. A triboelectric powder coating having a component which includes a triboelectric charging surface, said component being connected to a holder to form a two piece assembly, said two piece assembly being assembled into said gun.

45. The gun of claim 44 wherein said holder includes one ore more air jet passages.

46. The gun of claim 44 wherein said holder includes one or more electric ground elements.

47. A triboelectric powder coating gun having a triboelectric charging surface and an air jet which impinges on said charging surface, further including a ground element which is positioned upstream of said charging surface.

48. The coating gun of claim 47 comprising a plurality of air jets which direct air to impinge on said charging surface; said air jets being aligned with reference to a single vertical plane that lies transverse a longitudinal axis of said coating gun.

49. The coating gun of claim 48 wherein said ground element is disposed proximate said air jets.

50. A nozzle for a powder coating gun, comprising:
a body having a longitudinal axis and an axial passageway therein with an inlet for receiving powder entrained in an air flow; and
at least two slots that open to said passageway to produce a spray pattern; said slots being angled relative to said axis.

51. The nozzle of claim 50 wherein said slots produce converging powder flows to form said spray pattern.

52. The nozzle of claim 50 wherein said slots are aligned at substantially the same angle relative to said axis.

53. The nozzle of claim 52 wherein said angle is about 15 degrees.

54. The nozzle of claim 50 comprising at least one vent that directs air and powder towards a peripheral portion of said spray pattern.

55. The nozzle of claim 54 wherein said vent is disposed between said slots.

56. The nozzle of claim 55 comprising a plurality of said vents.

57. The nozzle of claim 55 comprising a negative tribocharging material.

58. The nozzle of claim 55 comprising a conical deflector that surrounds said body to shape said spray pattern to direct said pattern forwardly.

59. A nozzle for a powder coating gun, comprising:
a body having a longitudinal axis and an axial passageway therein with an inlet for receiving powder entrained in an air flow;
a powder flow deflector disposed at an outlet end of said axial passageway; said deflector being attached to said body to form a conical slot that opens to said passageway to produce a spray pattern.

60. The nozzle of claim 59 wherein said deflector has a cone shaped portion that faces said passageway.

61. The nozzle of claim 59 wherein said deflector is formed integral with said body.

62. The nozzle of claim 61 wherein said deflector is attached to said body by a plurality of ribs.

63. The nozzle of claim 59 comprising a conical deflector that surrounds said nozzle body to shape said spray pattern.

64. The nozzle of claim 63 wherein said conical deflector is slipped onto said nozzle body.

65. A hand held tribocharging gun for spraying powder coating material comprises a powder flow path, said powder flow path having a charging surface for triboelectrically charging powder coating material which comes in contact with said charging surface; a ground path for discharging said charging surface; a conductive handle gripped by an operator while using the gun; said handle and said ground path being connected to a common ground reference.

66. The apparatus of claim 65 wherein said gun comprises a conductive tube that provides said ground path.

67. The apparatus of claim 66 comprising a ground pin that electrically couples said charging surface to said conductive tube.

68. A modular powder coating gun, comprising:
a handle portion, a nozzle portion and an extension portion; said extension portion being slip fit inserted into a forward end of said handle portion and slip fit inserted into a rearward end of said nozzle assembly.

69. The assembly of claim 68 wherein said extension portion is conductive and provides a ground path for discharging electrostatic charge produced within said gun.

70. The assembly of claim 68 comprising a powder inlet tube that coextends with said extension portion; said inlet tube and extension portion forming an air annulus.

71. The assembly of claim 68 wherein said gun length can be changed by replacing a first extension portion with a second extension portion of different length; and changing length of said inlet tube in conformance with said length change.
